(19) United States
(12) Patent Application Publication
(10) Pub. No.: US 2019/0339840 A1
(43) Pub. Date: Nov. 7, 2019

(54) AUGMENTED REALITY DEVICE FOR RENDERING A LIST OF APPS OR SKILLS OF ARTIFICIAL INTELLIGENCE SYSTEM AND METHOD OF OPERATING THE SAME

(71) Applicant: Samsung Electronics Co., Ltd., Suwon-si (KR)

(72) Inventors: Jiyoon PARK, Suwon-si (KR); Seokhyun YOON, Suwon-si (KR); Cheolho CHEONG, Suwon-si (KR)

(21) Appl. No.: 16/390,484

(22) Filed: Apr. 22, 2019

Related U.S. Application Data
(60) Provisional application No. 62/665,316, filed on May 1, 2018.

(30) Foreign Application Priority Data
Feb. 28, 2019 (KR) 10-2019-0023751

(51) Int. Cl. G06F 3/0481; G06T 19/00; G02B 27/01; G10L 15/22

(52) U.S. Cl. CPC G06F 3/04815; G06T 19/006; G02B 2027/0178; G10L 15/22; G10L 2015/223; G02B 27/017

(57) ABSTRACT

An electronic device is provided. The electronic device includes a display, a camera, a wireless communication circuit, a processor operatively connected to the display, the camera, and the wireless communication circuit, and a memory operatively connected to the processor. The memory stores instructions that cause the processor to obtain an image including an external speech recognition-based artificial intelligence (AI) device, which is associated with an account of a user of the electronic device transmit first data including the image and context information to an external electronic device via the wireless communication circuit, receive second data including a list including names of applications installed in an AI system including the AI device, from the external electronic device via the wireless communication circuit, and display a graphical user interface (GUI) including the list based on the second data so as to be adjacent to or overlapped with the AI device.

### CROSS-REFERENCE TO RELATED APPLICATION(S)

This application is based on and claims priority under 35 U.S.C. § 119(e) of a U.S. Provisional application Ser. No. 62/665,316, filed on May 1, 2018, in the U.S. Patent and Trademark Office, and under 35 U.S.C. § 119(a) of a Korean patent application number 10-2019-0023751, filed on Feb. 28, 2019, in the Korean Intellectual Property Office, the disclosure of each of which is incorporated by reference herein in its entirety.

### BACKGROUND

### 1. Field

The disclosure relates to an electronic device. More particularly, the disclosure relates to an augmented reality (AR) device for rendering a list of apps or skills of an artificial intelligence system (AI system), and a method of operating the same.

### 2. Description of Related Art

With the development of speech recognition technology, a user may execute the function of an AI speaker through voice. The AI speaker may determine the intent of the user by analyzing the voice of the user and may determine the application corresponding to the determined intent. The AI speaker may provide a service according to the user's intent with voice by executing the determined application. For example, when the user says “What's the weather today?”, the AI speaker may determine that the user's intent is to make a request for weather information. The AI speaker may execute the weather application and may output a voice (e.g., “The highest temperature today is 19 degrees”) indicative of today's weather.

An AI system that includes an AI speaker as a user interface (UI) or as a stand-alone device may provide a user with a variety of functions through a plurality of applications (or apps) or skills. However, when the AI speaker does not include a display device such as a display or displays only the limited information due to the low resolution of the display, it is difficult for the user to identify or select the list or functions of applications preloaded onto the AI system or installed by the user. Furthermore, because only the applications, which are frequently used or remembered by the user, from among the applications supported by the AI system may be used, the usability for other applications may be reduced.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages, and to provide at least the advantages described below. Accordingly, an aspect of the disclosure is to provide an apparatus and method for providing an augmented reality (AR) electronic device that visually displays a list of applications (or content) of the AI system, thereby providing an environment in which a user can utilize various functions. Additional aspects will be set forth in part in the description which follows and, in part, will be apparent from the description, or may be learned by practice of the embodiments.

In accordance with an aspect of the disclosure, an electronic device is provided. The electronic device includes a display, a camera, a wireless communication circuit, a processor operatively connected to the display, the camera, and the wireless communication circuit, and a memory operatively connected to the processor. The memory may store instructions that, when executed, cause the processor to obtain an image including an external speech recognition-based AI device, which is associated with an account of a user of the electronic device, via the camera, transmit first data including the image and context information to an external electronic device via the wireless communication circuit, receive second data including a list including names of applications installed in an AI system including the AI device, from the external electronic device via the wireless communication circuit, and display a graphical user interface (GUI) including the list via the display based on the second data so as to be adjacent to or overlapped with the AI device.

In accordance with another aspect of the disclosure, a system is provided. The system includes at least one communication interface, at least one processor operatively connected to the communication interface, and at least one memory operatively connected to the processor. The memory may store information about an external speech recognition device. The memory may store instructions, that when executed, cause the processor to receive first data including an image and context information, from an augmented reality (AR) electronic device associated with a user account of the external speech recognition device via the communication interface, recognize the speech recognition device included in the image, determine a list of applications installed in an AI system including the speech recognition device, based on the context information and the information about the speech recognition device stored in the memory, and transmit second data including the list of the applications to the AR electronic device via the communication interface.

In accordance with another aspect of the disclosure, a method of operating an electronic device in an AR environment is provided. The method includes obtaining an image including an external speech recognition-based AI device, which is associated with a user account of the electronic device, transmitting first data including the image and context information to an external electronic device, receiving second data including a list including names of applications installed in an AI system including the AI device, from the external electronic device, and displaying a GUI including the list, based on the second data so as to be adjacent to or overlapped with a speech recognition device.

Other aspects, advantages, and salient features of the disclosure will become apparent to those skilled in the art from the following detailed description, which, taken in conjunction with the annexed drawings, discloses embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network environment according to embodiments of the disclosure;

FIG. 2 illustrates an operation of displaying content of applications supported by a speech recognition device, in an augmented reality (AR) environment according to embodiments of the disclosure;

FIG. 3 illustrates a block diagram of a wearable device according to embodiments of the disclosure;

FIG. 4 is a block diagram of an electronic device in a network environment according to embodiments of the disclosure;

FIG. 5 is a block diagram of a server according to embodiments of the disclosure;

FIG. 6 illustrates an operation flowchart for displaying content of applications supported by a speech recognition device according to embodiments of the disclosure;

FIG. 7A illustrates an operation flowchart for displaying content of applications supported by a speech recognition device according to embodiments of the disclosure;

FIG. 7B illustrates another operation flowchart for displaying content of applications supported by a speech recognition device according to embodiments of the disclosure;

FIG. 8 illustrates an operation flowchart for determining an application list based on a type of speech recognition device according to embodiments of the disclosure;

FIG. 9A is a flowchart of operations of an electronic device for displaying content of applications according to embodiments of the disclosure;

FIG. 9B is a flowchart of operations of a server for determining an application list according to embodiments of the disclosure;

FIG. 10 illustrates a connection environment in which a speech recognition device is included according to embodiments of the disclosure;

FIG. 11 is a block diagram of an artificial intelligence (AI) system for executing a speech recognition device according to embodiments of the disclosure;

FIG. 12 illustrates a user interface (UI) for displaying an application to be recommended to a user according to embodiments of the disclosure;

FIG. 13 illustrates a network environment including an edge server according to embodiments of the disclosure;

FIG. 14 illustrates an operation flowchart for determining an application list based on an edge server according to embodiments of the disclosure;

FIG. 15 illustrates a UI including content in an AR environment according to embodiments of the disclosure;

FIG. 16 illustrates another example of a UI including content in an AR environment according to embodiments of the disclosure;

FIG. 17 illustrates another example of a UI including content in an AR environment according to embodiments of the disclosure; and

FIG. 18 illustrates another example of a UI for displaying AR content in an AR environment based on a user account according to embodiments of the disclosure.

Throughout the drawings, like reference numerals will be understood to refer to like parts, components, and structures.

### DETAILED DESCRIPTION

The following description with reference to the accompanying drawings is provided to assist in a comprehensive understanding of embodiments of the disclosure as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used to enable a clear and consistent understanding of the disclosure. Accordingly, it should be apparent to those skilled in the art that the following description of embodiments of the disclosure is provided for illustration purpose only, and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

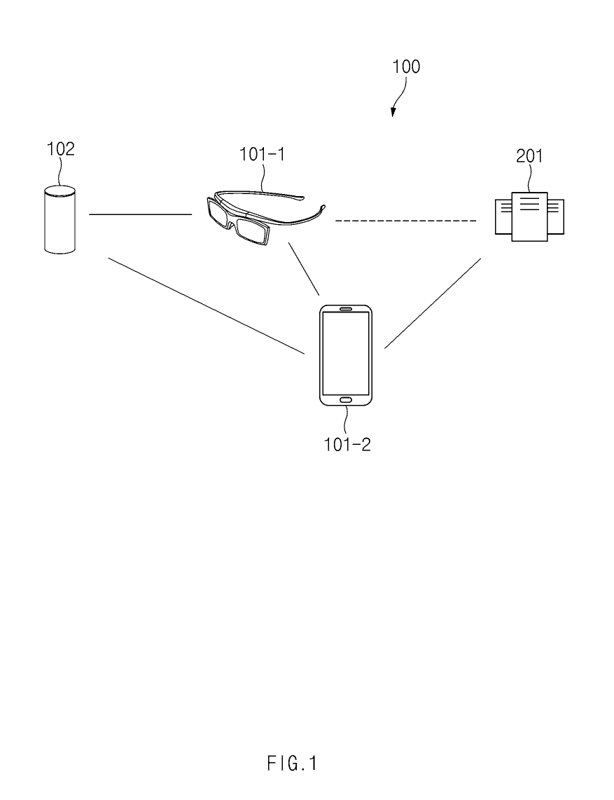

FIG. 1 illustrates a network environment according to embodiments of the disclosure.

Referring to FIG. 1, a network environment 100 may include a wearable device 101-1, a user terminal 101-2, a speech recognition device 102, and a server 201.

According to an embodiment of the disclosure, the speech recognition device 102 may mean a device that receives a user utterance and then performs actions according to the user utterance. For example, the speech recognition device 102 may include an artificial intelligence (AI) speaker. As another example, the speech recognition device 102 may include at least one of an Internet of Things (IoT) device or a home appliance that is capable of performing actions according to the user utterance. As another example, the speech recognition device 102 may include a thermostat.

According to an embodiment of the disclosure, while the wearable device 101-1 or the user terminal 101-2 receives the image of the speech recognition device 102 via an image sensor, one or more of the wearable device 101-1 or the user terminal 101-2 may be configured to visually provide a user with a list of applications or skills (hereinafter, collectively referred to as “applications” or “apps”) supported by the speech recognition device 102 in an augmented reality (AR) mode. For example, the list may include at least one of a text, an image, a video, an icon, or a symbol associated with the applications. The list may also provide a text including names used to call the apps using a voice command.

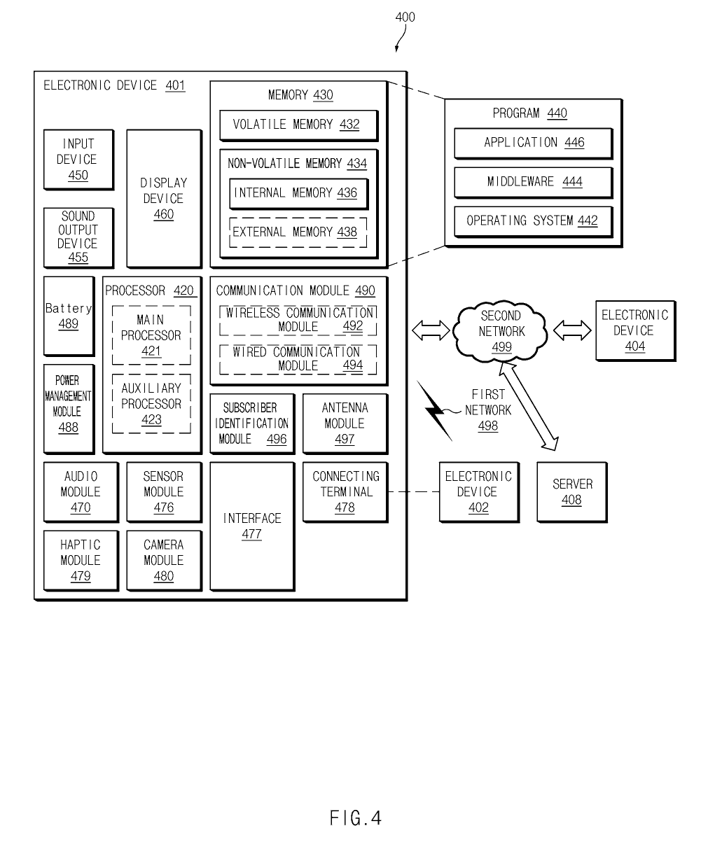

The wearable device 101-1 may include a head mounted display (HMD) device or an AR device. The user terminal 101-2 may include a smartphone or a tablet personal computer (PC). In an embodiment of the disclosure, the user terminal 101-2 may be used instead of the AR device. According to an embodiment, the user terminal 101-2 may be operatively coupled to the wearable device 101-1 by using wireless (Bluetooth (BT), Wi-Fi, or a cellular network) communication or wired (universal serial bus (USB) Type-C) communication. For example, the user terminal 101-2 may analyze the image of the speech recognition device 102 received from the wearable device 101-1, may receive content (e.g., one or more of the list, a graphical user interface (GUI), notification information, or an app screen) associated with the speech recognition device 102 from the server 201 over a long range wireless communication network (e.g., a second network 499 of FIG. 4), may link the received content to the location of the image of the speech recognition device 102, and may transmit the linked location information and the content to the wearable device 101-1. Therefore, the user terminal 101-2 may induce the wearable device 101-1 to display the content. For another example, the wearable device 101-1 may analyze the image of the speech recognition device 102 received from the user terminal 101-2, may receive the content associated with the speech recognition device 102 from the server 201 over a long range wireless communication network, may link the received content to the location of the image of the speech recognition device 102, and may transmit the linked location information and the content to the user terminal 101-2. Therefore, the wearable device 101-1 may induce the user terminal 101-2 to display the content.

According to an embodiment of the disclosure, the user terminal 101-2 may be physically or operatively coupled to the wearable device 101-1. For example, when a user wears the wearable device 101-1 in a state where the user terminal 101-2 is coupled to the wearable device 101-1, the user terminal 101-2 may provide the user with the content of applications via a display in the AR mode. For example, the user terminal 101-2 may provide one or more of video-type AR or see-through AR via a display in the AR mode. The video-type AR refers to a method in which an electronic device composes the image received through a camera, which becomes a background, and virtual information (e.g., content) to display the composed result via a display. The see-through AR may be formed of a transparent or translucent material such that at least part of the display receives external light, and thus the user may watch the outside through his/her eyes. An electronic device displays virtual information on the display, and thus the user may watch both the outside and the virtual information.

According to an embodiment of the disclosure, the server 201 may provide information about applications supported by the speech recognition device 102 to the electronic device 101 (e.g., the wearable device 101-1 or the user terminal 101-2). In the AR mode, the electronic device 101 may display the content of applications of the speech recognition device 102, based on the information received from the server 201. According to an embodiment, in the AR mode, the electronic device 101 may display the pieces of content of the applications of the speech recognition device 102, based on the application information pre-stored in the memory of the electronic device 101 and the information received from the server 201. For example, the electronic device 101 may sort the content corresponding to the pre-stored information and the pieces of content corresponding to the received information on the electronic device 101, depending on priorities and then may display the sorted result. For example, the electronic device 101 may display a group including pieces of content corresponding to the information pre-stored in the electronic device 101 and a group including pieces of content corresponding to the received information separately at different locations. The electronic device 101 may display the two groups separately with different colors.

According to an embodiment of the disclosure, the wearable device 101-1 and the user terminal 101-2 may communicate with the server 201 over a long-range wireless communication network (e.g., the second network 499 of FIG. 4). In this case, a base station (not illustrated) or an access point (AP) (not illustrated) may be interposed between the wearable device 101-1, the user terminal 101-2, and the server 201. According to another embodiment of the disclosure, when the wearable device 101-1 does not include a communication interface supporting a long-range wireless communication network, the wearable device 101-1 may perform wireless communication with the server 201 via the user terminal 101-2.

According to an embodiment of the disclosure, the electronic device 101 may obtain an image including the speech recognition device 102. The electronic device 101 may transmit, to the server 201, context information associated with the image and the electronic device. For example, the context information may include at least one of the location information of the electronic device 101, information about a time at which the image is obtained, or the user account information of the electronic device 101. The server 201 may recognize the speech recognition device 102 by analyzing the received image. The server 201 may determine a list of applications supported by the recognized speech recognition device 102 based on the context information, and may transmit the determined list of applications to the electronic device 101.

According to an embodiment of the disclosure, an external electronic device (e.g., the speech recognition device 102, PC, television (TV), or a smartphone of another user) may obtain an image including the speech recognition device 102 from the electronic device 101. Context information associated with the external electronic device, the image and the electronic device may be transmitted to the server 201. The server 201 may recognize the speech recognition device 102 by analyzing the received image. The server 201 may determine a list of applications supported by the speech recognition device 102 recognized based on the context information, and may transmit the determined list of applications to the external electronic device. The external electronic device may transmit the determined list of applications to the electronic device 101.

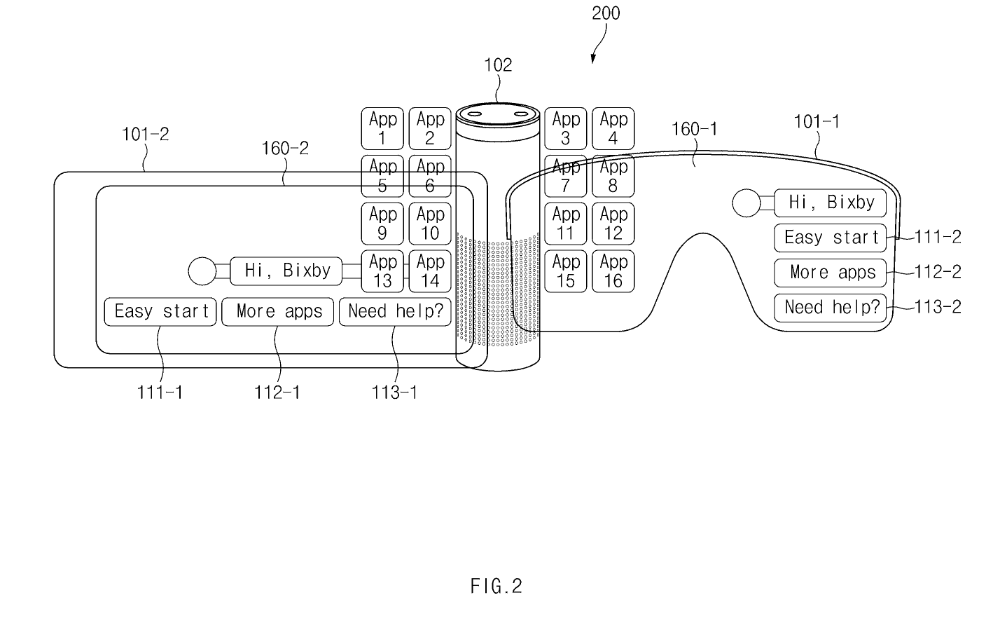

FIG. 2 illustrates an operation of displaying a list of applications supported by a speech recognition device in an AR environment according to an embodiment of the disclosure.

Referring to FIG. 2, the wearable device 101-1 and/or the user terminal 101-2 may include displays 160-1 and 160-2. The displays 160-1 and 160-2 may support an AR mode in an AR environment 200. For example, information (e.g., an image, location information, a device identifier (ID) (a device name, a model name, a wireless ID), or an operational status) about the speech recognition device 102 may be received by the sensor (e.g., an image sensor, a proximity sensor, a wireless signal sensor, or an electromagnetic field sensor) of the electronic device 101. Alternatively, while the speech recognition device 102 is displayed via the displays 160-1 and 160-2, the wearable device 101-1 or the user terminal 101-2 may display information (in particular, the name used for a call with voice) about applications (e.g., 1, 2, . . . , 16) supported by the speech recognition device 102, on a partial region of the displays 160-1 and 160-2.

According to an embodiment illustrated in FIG. 2, the wearable device 101-1 or the user terminal 101-2 may display the list of applications on the region at a periphery of the speech recognition device 102, via the displays 160-1 and 160-2. According to another embodiment, the wearable device 101-1 or the user terminal 101-2 may display the list of applications on a region that at least partly overlaps with the speech recognition device 102. The wearable device 101-1 or the user terminal 101-2 may check apps, which a user can utilize through the speech recognition device 102, by visually displaying the list of applications via the displays 160-1 and 160-2 and may provide an environment capable of easily performing a voice command.

According to an embodiment of the disclosure, the wearable device 101-1 or the user terminal 101-2 may display the list of applications, in response to a user utterance (e.g., “Hi, Bixby”) for calling the speech recognition device 102.

According to an embodiment of the disclosure, a wake-up utterance that prepares to perform a voice command may vary for each speech recognition device. For example, wake-up utterances may be different from each other as provided by the manufacturer of the speech recognition device, the product model, or the designation of the user. When the wake-up utterance is uttered by the user, the electronic device 101 may receive the wake-up utterance, may determine the speech recognition device 102 corresponding to the wake-up utterance, may select the pieces of content of applications corresponding to the determined speech recognition device 102, and may display the selected pieces of content on the display 160 of the electronic device 101.

According to an embodiment of the disclosure, when the image of the determined speech recognition device 102 is received by the electronic device 101 during a first time (e.g., 0.5 sec) or more, an operation of displaying the selected content may include an operation of displaying the selected content on a display based on the location of the received image of the speech recognition device 102. In addition, for the purpose of terminating the operation of displaying the selected content, when the image of the determined speech recognition device 102 is received by the electronic device 101 during a second time (e.g., 10 seconds) or more, or when the image of the determined speech recognition device 102 is not received by the electronic device 101 during a third time (e.g., one second) or more, the operation of displaying the selected content may be terminated.

According to an embodiment of the disclosure, in the operation of displaying the selected content, when the image of the determined speech recognition device 102 is not received by the electronic device 101, the electronic device 101 may set the first parameter for displaying the selected content on the display. When an image of the determined speech recognition device 102 is received by the electronic device 101, the electronic device 101 may link the selected content to the image of the determined speech recognition device 102 to set the second parameter. Each of the first parameter and the second parameter may include at least one or more attributes of a location on the display, a size, a color, and transparency, whether an object is matched, and projection, for displaying the selected content. At least one or more of attributes of each of the first parameter and the second parameter may be assigned differently from each other. For example, by setting of the first parameter, the selected content may be displayed while being fixed without matching the object to the first region (e.g., lower end) of the display, by applying a first size or first translucency. For example, by setting of the second parameter, the selected content may be linked to the location of the determined speech recognition device 102 and may be displayed on a display. One or more of the location, size, and translucency of the display may be set differently from those of the first parameter. As another example, at least two or more of the detailed attributes included in the first parameter and the second parameter may be set differently. As such, in the operation of displaying the selected content, when the case where the image of the determined speech recognition device 102 is not received by the electronic device 101 is changed to the case where the image of the determined speech recognition device 102 is received by the electronic device 101, or when the case where the image of the determined speech recognition device 102 is received by the electronic device 101 is changed to the case where the image of the determined speech recognition device 102 is not received by the electronic device 101, a method of displaying the selected content may be changed. Because the attributes for displaying the selected content change during the case change, the animation effect may be added by gradually changing the variation in each of the attributes (e.g., calculating and applying the variation in motion, size, color, or transparency in the interpolation manner), thereby reducing or minimizing the cognitive confusion of a user due to rapid changes. In an embodiment of the disclosure, when a user input for selecting a menu (e.g., 111-1 or 111-2) for recommending an application is received, the wearable device 101-1 or the user terminal 101-2 may recommend an application to the user. According to an embodiment, a processor 330 of the wearable device 101-1 or the user terminal 101-2 may calculate data indicating the priorities of applications, or may receive data indicating the priorities of applications from the server 201, and then may recommend an application to a user based on the calculated or received data, or the pieces of data.

According to an embodiment of the disclosure, the wearable device 101-1 or the user terminal 101-2 may further display a menu (e.g., 112-1 or 112-2) for checking a list of other applications or a menu (e.g., 113-1 or 113-2) for describing to the user how to use the displayed features.

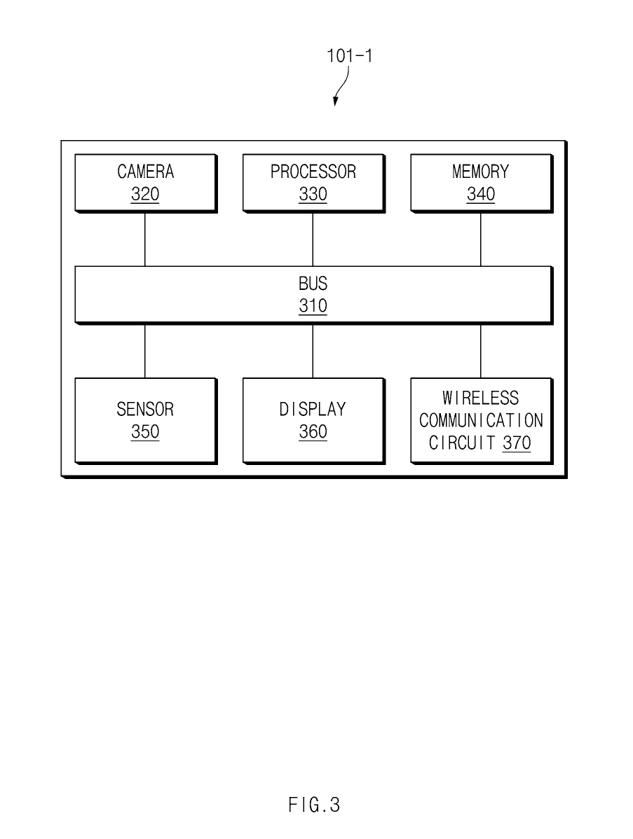

FIG. 3 is a block diagram of a wearable device according to an embodiment of the disclosure.

Referring to FIG. 3, the wearable device 101-1 may include a camera 320, the processor 330, a memory 340, a sensor 350, a display 360 (e.g., the display 160-1 of FIG. 2), and a wireless communication circuit 370, which are operatively connected via a bus 310. According to an embodiment of the disclosure, at least part of the components illustrated in FIG. 3 may be omitted in the wearable device 101-1. Alternatively, the wearable device 101-1 may further include at least one component (e.g., the component of an electronic device 401 of FIG. 4), which is not illustrated in FIG. 3.

According to an embodiment of the disclosure, the camera 320 may be disposed on the front surface of the wearable device 101-1. In a state where the wearable device 101-1 is worn by a user, the camera 320 may obtain the image of an object, which the user watches or which is positioned in a direction close or similar to a direction in which the user's head faces. For example, the camera 320 may capture an image corresponding to the gaze direction, when the camera 320 is positioned in the direction opposite to a direction in which the display displays information or when the camera 320 is positioned in the direction in which the HMD worn by the user faces. Alternatively, the camera 320 may capture an image corresponding to the gaze direction, based on the user's gaze tracking sensor information.

According to an embodiment of the disclosure, the sensor 350 may include at least one of a gesture sensor, a grip sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

According to an embodiment of the disclosure, the display 360 may include a see-through display to support the AR function.

According to an embodiment of the disclosure, the wireless communication circuit 370 may perform a function the same as or at least partly similar to that of a wireless communication module 492 of the electronic device 401 of FIG. 4. The wireless communication circuit 370 may support a short-range wireless communication network or a long-range wireless communication network. According to an embodiment, for the purpose of reducing the weight of the wearable device 101-1, the wireless communication circuit 370 may support only a short-range wireless communication network.

According to an embodiment of the disclosure, the processor 330 may perform the overall functions of the wearable device 101-1 for displaying the content of applications. The processor 330 may perform functions by executing instructions stored in the memory 340.

FIG. 4 is a block diagram illustrating an electronic device in a network environment according to embodiments of the disclosure.

Referring to FIG. 4, the electronic device 401 in a network environment 400 may communicate with an electronic device 402 via a first network 498 (e.g., a short-range wireless communication network), or an electronic device 404 or a server 408 via the second network 499 (e.g., a long-range wireless communication network). According to an embodiment of the disclosure, the electronic device 401 may communicate with the electronic device 404 via the server 408. According to an embodiment, the electronic device 401 may include a processor 420, memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) 496, or an antenna module 497. In some embodiments, at least one (e.g., the display device 460 or the camera module 480) of the components may be omitted from the electronic device 401, or one or more other components may be added in the electronic device 401. In some embodiments, some of the components may be implemented as single integrated circuitry. For example, the sensor module 476 (e.g., a fingerprint sensor, an iris sensor, or an illuminance sensor) may be implemented as embedded in the display device 460 (e.g., a display).

The processor 420 may execute, for example, software (e.g., a program 440) to control at least one other component (e.g., a hardware or software component) of the electronic device 401 coupled with the processor 420, and may perform various data processing or computation. According to one embodiment, as at least part of the data processing or computation, the processor 420 may load a command or data received from another components (e.g., the sensor module 476 or the communication module 490) in volatile memory 432, process the command or the data stored in the volatile memory 432, and store resulting data in non-volatile memory 434. According to an embodiment, the processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or to be specific to a specified function. The auxiliary processor 423 may be implemented as separate from, or as part of the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). According to an embodiment, the auxiliary processor 423 (e.g., an ISP or a CP) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. The non-volatile memory 434 may include an internal memory 436 or external memory 438.

The program 440 may be stored in the memory 430 as software, and may include, for example, an operating system (OS) 442, middleware 444, or an application 446.

The input device 450 may receive a command or data to be used by other components (e.g., the processor 420) of the electronic device 401, from the outside (e.g., a user) of the electronic device 401. The input device 450 may include, for example, a microphone, a mouse, a keyboard, or a digital pen (e.g., a stylus pen).

The sound output device 455 may output sound signals to the outside of the electronic device 401. The sound output device 455 may include, for example, a speaker or a receiver. The speaker may be used for general purposes, such as playing multimedia or playing recordings, and the receiver may be used for incoming calls and the like. According to an embodiment, the receiver may be implemented as separate from, or as part of the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. According to an embodiment of the disclosure, the display device 460 may include touch circuitry adapted to detect a hovering or touch, or sensor circuitry (e.g., a pressure sensor) adapted to measure the intensity of force incurred by the touch.

The audio module 470 may convert sound into an electrical signal and convert an electrical signal into sound. According to an embodiment of the disclosure, the audio module 470 may obtain the sound via the input device 450, or output the sound via the sound output device 455 or a headphone of an external electronic device (e.g., an electronic device 402) directly (e.g., wiredly) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. According to an embodiment of the disclosure, the sensor module 476 may include, for example, a gesture sensor, a gyro sensor, an atmospheric pressure sensor, a magnetic sensor, an acceleration sensor, a grip sensor, a proximity sensor, a color sensor, an IR sensor, a biometric sensor, a temperature sensor, a humidity sensor, or an illuminance sensor.

The interface 477 may support one or more specified protocols to be used for the electronic device 401 to be coupled with an external electronic device (e.g., the electronic device 402) directly (e.g., wiredly) or wirelessly. According to an embodiment, the interface 477 may include, for example, a high definition multimedia interface (HDMI), a USB interface, a secure digital (SD) card interface, or an audio interface.

A connecting terminal 478 may include a connector via which the electronic device 401 may be physically connected with an external electronic device (e.g., the electronic device 402). According to an embodiment of the disclosure, the connecting terminal 478 may include, for example, a HDMI connector, a USB connector, an SD card connector, or an audio connector (e.g., a headphone connector).

The haptic module 479 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 479 may include, for example, a motor, a piezoelectric element, or an electric stimulator.

The camera module 480 may capture still images or moving images. According to an embodiment of the disclosure, the camera module 480 may include one or more lenses, image sensors, ISPs, or flashes.

The power management module 488 may manage power supplied to or used by the electronic device 401. According to one embodiment, the power management module 488 may be implemented as at least part of, for example, a power management integrated circuit (PMIC).

The battery 489 may supply power to at least one component of the electronic device 401. According to an embodiment, the battery 489 may include, for example, a primary cell which is not rechargeable, a secondary cell which is rechargeable, a fuel cell, or combinations thereof.

The communication module 490 may support establishing a direct (e.g., wired) communication channel or a wireless communication channel between the electronic device 401 and an external electronic device (e.g., the electronic device 402, the electronic device 404, or the server 408) and performing communication via the established communication channel. The communication module 490 may include one or more CPs that are operable independently from the processor 420 (e.g., the application processor (AP)) and support a direct (e.g., wired) communication or a wireless communication. According to an embodiment of the disclosure, the communication module 490 may include the wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with an external electronic device via the first network 498 (e.g., a short-range communication network, such as Bluetooth™, wireless-fidelity (Wi-Fi) direct, or infrared data association (IrDA)), or the second network 499 (e.g., a long-range communication network, such as a cellular network, the Internet, or a computer network (e.g., LAN or wide area network (WAN)). These various types of communication modules may be implemented as a single component (e.g., a single chip), or may be implemented as multi-components (e.g., multi-chips) separate from each other. The wireless communication module 492 may identify and authenticate the electronic device 401 in a communication network, such as the first network 498 or the second network 499, using subscriber information (e.g., international mobile subscriber identity (IMSI)) stored in the SIM 496.

The antenna module 497 may transmit or receive a signal or power to or from the outside (e.g., the external electronic device) of the electronic device 401. According to an embodiment of the disclosure, the antenna module 497 may include an antenna including a radiating element composed of a conductive material or a conductive pattern formed in or on a substrate (e.g., printed circuit board (PCB)). According to an embodiment of the disclosure, the antenna module 497 may include a plurality of antennas. In such a case, at least one antenna appropriate for a communication scheme used in the communication network, such as the first network 498 or the second network 499, may be selected, for example, by the communication module 490 (e.g., the wireless communication module 492) from the plurality of antennas. The signal or power may then be transmitted or received between the communication module 490 and an external electronic device via the selected at least one antenna. According to an embodiment of the disclosure, another component (e.g., a radio frequency integrated circuit (RFIC)) other than the radiating element may be additionally formed as part of the antenna module 497.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 401 and the external electronic device 404 via the server 408 coupled with the second network 499. Each of the electronic devices 402 and 404 may be a device of a same type, or a different type, as the electronic device 401. According to an embodiment of the disclosure, all or some of operations to be executed at the electronic device 401 may be executed at one or more of the external electronic devices 402, 404, or 408. For example, if the electronic device 401 is to perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

According to an embodiment of the disclosure, the electronic device 401 may correspond to the user terminal 101-2 of FIG. 2 or the electronic device 101 of FIG. 1, and the server 408 may correspond to the server 201 of FIG. 1.

According to an embodiment of the disclosure, the processor 420 may perform the overall functions of the electronic device 401 for displaying the content of applications. The processor 420 may perform such functions by executing instructions stored in the memory 430.

According to an embodiment of the disclosure, the processor 420 may obtain location information of the electronic device 401 via the wireless communication module 492. For example, the processor 420 may obtain location information of the wearable device 101-1 based on at least one of a global positioning system (GPS), advanced GPS (A-GPS), GNSS, cell ID, ultra-wide band (UWB), light fidelity (LiFi), BT, a depth sensor, an ultrasound sensor, geo-fence, cellular, or Wi-Fi. As another example, the processor 420 may obtain location information of the electronic device 401 based on the network information of the network to which the electronic device 401 is connected. For example, the network information may include at least one of the type of the network, the speed of the network, the connectivity of the network, the capability of the network, the service availability of the network, or information of an edge server accessed by the electronic device 401. The edge server may be a server that supports multi-access edge computing or mobile edge computing (MEC) or fog computing functions. In one embodiment, an edge server may be a server connected to a base station of a network without going through a core network. The edge server may be operated by a carrier running the network.

According to an embodiment of the disclosure, the processor 420 may obtain an image including the speech recognition device 102, via the camera module 480. The processor 420 may transmit first data including the image and context information to an external electronic device (e.g., the server 201) via the wireless communication module 492.

According to an embodiment of the disclosure, the processor 420 may receive second data including a list of applications via the wireless communication module 492.

According to an embodiment of the disclosure, the processor 420 may display the content of applications, which the speech recognition device 102 is capable of supporting, via the display device 460 based on the second data.

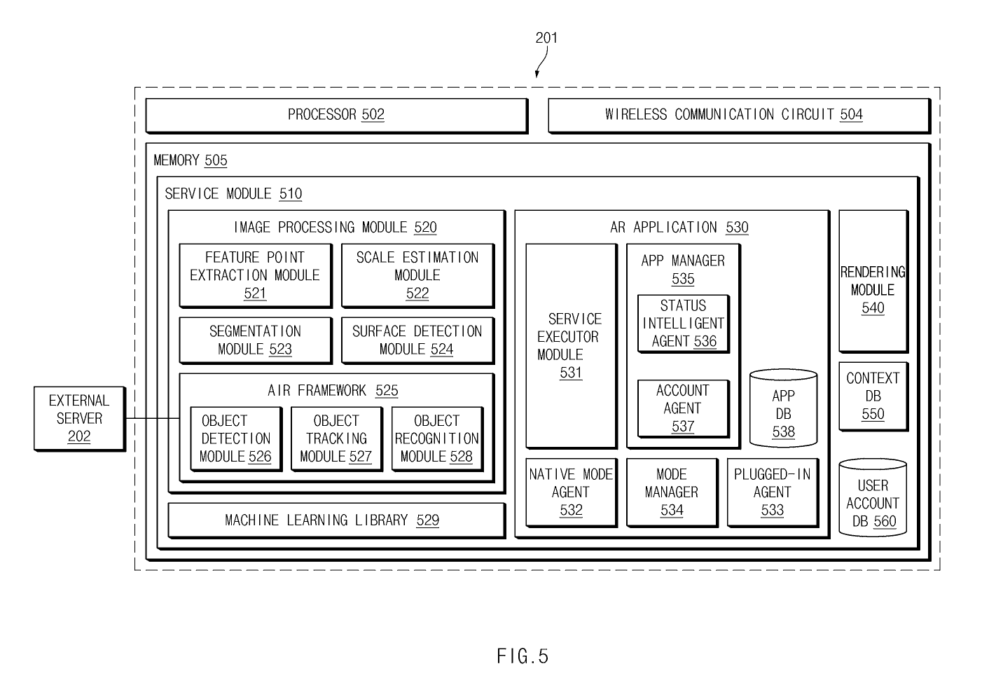

FIG. 5 is a block diagram of a server according to embodiments of the disclosure.

Referring to FIG. 5, the server 201 may include a processor 502, a wireless communication circuit 504, and a memory 505.

According to an embodiment of the disclosure, the wireless communication circuit 504 may be configured to perform wireless communication with the electronic device 101 (e.g., the wearable device 101-1 or the user terminal 101-2).

According to an embodiment of the disclosure, the processor 502 may be operatively connected to the wireless communication circuit 504 and the memory 505. The processor 502 may perform overall functions of the server 201 that determines a list of applications supported by the speech recognition device 102, by executing a service module 510 stored in the memory 505.

According to an embodiment of the disclosure, the memory 505 may include the service module 510. The service module 510 may be a set of instructions executed by the processor 502, and may include an image processing module 520, a machine learning library 529, an AR application 530, a rendering module 540, a context database (DB) 550, and a user account DB 560.

According to an embodiment of the disclosure, the image processing module 520 may include components for recognizing the subject (e.g., the speech recognition device 102) included in the image. The image processing module 520 may include a feature point extraction module 521, a scale estimation module 522, a segmentation module 523, and a surface detection module 524. The feature point extraction module 521 may extract the feature point of a subject included in the image. The scale estimation module 522 may determine the amount or volume of the subject by analyzing depth information or length information. The segmentation module 523 may separate the subject from a background in an image. The surface detection module 524 may recognize the subject or may calculate information for displaying the subject on a surface by analyzing at least one of a plane, a curved surface, a distance, or a texture.

According to an embodiment of the disclosure, the image processing module 520 may include an advanced image recognition (AIR) framework 525 for receiving information associated with the image processing from an external server 202. The AIR framework 525 may include an object detection module 526, an object tracking module 527, and an object recognition module 528. The object detection module 526 may identify the subject separated through the segmentation module 523 and may extract a region of interest (ROI). The object tracking module 527 may track at least one of the feature point, subject, or ROI of the image continuously input through the preview of the camera (e.g., 320) or may track the specified marker. The object recognition module 528 may identify the primary category of the subject. For example, the primary category may include a type of subject (e.g., food, a book, an electronic device, a flower, a car, a person). The object recognition module 528 may receive a secondary category (e.g., a type of food, a type of electronic device) of the subject or information (e.g., calorie of food, nutrient, or a model name) associated with the subject, from the external server 202. For example, the first category of the speech recognition device 102 may be an electronic device; the secondary category may be an AI speaker, and related information may include the model name of the AI speaker.

According to an embodiment of the disclosure, for the purpose of performing image processing through machine learning, the server 201 or the electronic device 101 may include the machine learning library 529.

According to an embodiment of the disclosure, the AR application 530 may execute applications supported by the speech recognition device 102 and may perform a function for visually displaying content in the AR mode via the wearable device 101-1 or the user terminal 101-2. The AR application 530 may include a service executor module 531, a native mode agent 532, a plugged-in agent 533, and a mode manager 534, an APP manager 535, and an APP database (DB) 538. The service executor module 531 may execute an application. The native mode agent 532 may manage applications installed in the speech recognition device 102 in advance. The plugged-in agent 533 may manage one or more of application ID information or control and status information of installation, deletion, or execution of an application (e.g., the 3^{rd} party application) additionally and separately installed by a user or a system. The mode manager 534 may manage the permission of the functions available in the plugged-in agent 533. The APP DB 538 may store information about applications. The APP manager 535 may manage an application that is executable in a native mode or a plugged-in mode. The APP manager 535 may include a status intelligent agent 536 and an account agent 537. The status intelligent agent 536 may set the start point and the state value of the application based on the data stored in a sensor, a memory, or a user profile. The account agent 537 may manage the user's usage history or the user's schedule.

According to an embodiment of the disclosure, the rendering module 540 may generate and store information for rendering the execution screen of the application or the content of applications.

According to an embodiment of the disclosure, the user account DB 560 may store one or more pieces of user account information registered in the electronic device 101 or the speech recognition device 102. For example, the user account information may include at least one of identification information (one or more of a user, an electronic device of the user, a speech recognition device, or an application), usage history, the preference set by the user's selection, or the user's schedule. The information stored in the user account DB 560 may be used to determine at least one of the category, number, or priority of applications. For example, the user account may be associated with an external server (e.g., a server of the manufacturer of the speech recognition device) operatively connected to the speech recognition device 102. In this case, the electronic device 101 may use a function that allows the user to select and manage the skill or application provided by the speech recognition device 102 such that the user inquires or utilizes the skill or application by accessing the external server using the user account. For example, the user account may be a user account associated to use the service module 510 included in the external server (not illustrated) operatively connected to the electronic device 101. As another example, a plurality of user accounts included in the user account DB 560 of the electronic device 101 may be information associated such that the electronic device 101 uses a speech recognition device management function and the service module 510, which are included in each of different external servers. In this case, the electronic device 101 may be allowed to access the server 201 through the first user account dedicated to the server 201, which includes the service module 510, may identify the speech recognition device 102 using the server 201 to receive the speech recognition device information identified by the electronic device 101, and may access an external server that provides a speech recognition device management function using a second user account corresponding to the received speech recognition device 102 and thus, may control the functionality of the speech recognition device 102.

According to an embodiment of the disclosure, the category of an application may be information for classifying or grouping applications based on one or more of a skill or application type (e.g., music streaming, a payment service, a food recommendation service, a navigation service, weather/traffic information service, or the like), or the state of an application (e.g., whether an application is activated to be used, the preference for each user, an application list capable of being displayed for each user, whether authentication is required to use the application, whether personal information of an application is used, a location where an application is used, or the like). For example, a plurality of music playing applications may be included in the music playing application category, and the priorities of applications belonging to the category of the music playing application may be determined based on the user's preference. For example, applications belonging to the category of a single application may be classified or grouped for each sub-category.

According to an embodiment of the disclosure, the context DB 550 may store information used to determine at least one of the category, number, or priorities of applications included in the list of applications. For example, the context DB 550 may store the context information received from the electronic device 101. As another example, the context DB 550 may store information about the speech recognition device 102. For example, the information about the speech recognition device 102 may include at least one of the primary category, the secondary category, a model name, capability, a usage history, information about a network connected by the speech recognition device 102, or information of an edge server to which the speech recognition device 102 is connected.

An embodiment is exemplified in FIG. 5 as the server 201 includes the service module 510. However, according to another embodiment, the service module 510 may be included in the user terminal 101-2. In this case, in FIG. 2, the user terminal 101-2 may replace the function of the server 201. According to still another embodiment, the service module 510 may be included in both the user terminal 101-2 and the server 201. In this case, the service modules of the two devices may perform distributed processing on information with each other or may complement the information with each other.

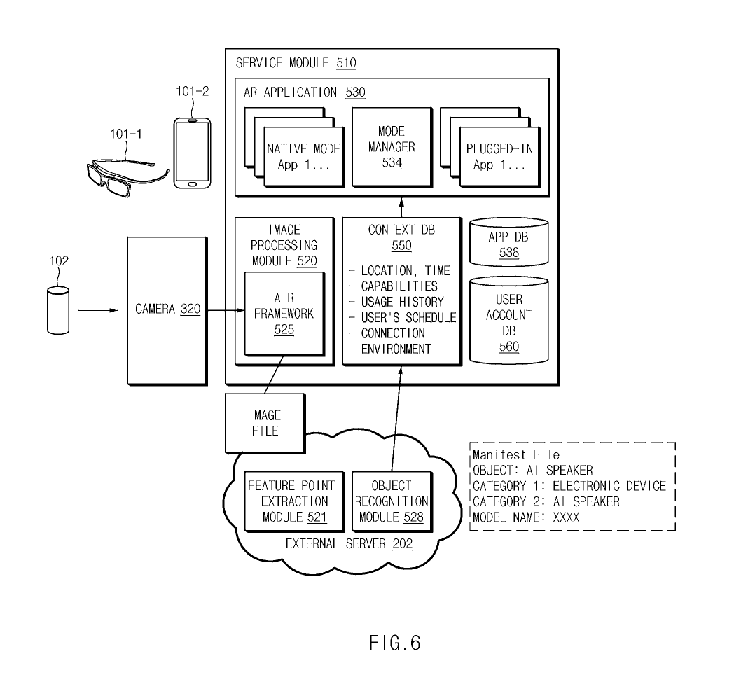

FIG. 6 illustrates an operation flowchart for displaying content of applications supported by a speech recognition device according to embodiments of the disclosure.

Referring to FIG. 6, the wearable device 101-1 or the user terminal 101-2 may obtain an image of the speech recognition device 102 using the camera 320 or 480. The wearable device 101-1 or the user terminal 101-2 may transmit the first data including the obtained image and context information to the service module 510 included in the server 201. As another example, when the wearable device 101-1 or the user terminal 101-2 includes the service module 510, the electronic device 101 may directly process images using the service module 510. As still another example, when the electronic device 101 includes a first service module 510 and the server 201 includes a second service module 510, the electronic device 101 may process an image based on the result processed by the first service module and the result processed by the second service module by exchanging information with the server 201 via a wired/wireless communication circuit. For example, when the processing fails in the first service module, the image may be processed by the second service module. For example, the first service module and the second service module may perform distributed processing on the image.

According to an embodiment of the disclosure, the server 201 may analyze the image using the image processing module 520. When the feature point extraction module 521 and the object recognition module 528 are included in the external server 202, the server 201 may analyze the image by sharing image data (e.g., an image file, image bit stream, and raw data received by a camera sensor) with the external server 202. The server 201 may recognize that a subject (or object) included in the image is an AI speaker based on image analysis. For example, the server 201 may recognize that the primary category of the subject included in the image is an electronic device, the secondary category is an AI speaker, and the model name is “xxxx”.

According to an embodiment of the disclosure, the server 201 may select applications supported by the speech recognition device 102 from the APP DB 538 based on the context information. For example, the server 201 may determine the type of the speech recognition device 102 based on the location information and may select applications corresponding to the determined type from the APP DB 538. As another example, the server 201 may identify the user account information of the speech recognition device 102 based on the user account information of the wearable device 101-1 or the user terminal 101-2 included in the context information and may select applications corresponding to the identified user account information.

According to an embodiment of the disclosure, the server 201 may determine at least one of the types, number, and priorities of the applications, using the information stored in the context DB 550 or the user account DB 560. For example, when the location where the speech recognition device 102 is located is the user's home and the present time is dinner time, the server 201 may preferentially select food delivery applications and may determine an arrangement sequence based on the usage frequency. As another example, when the location where the speech recognition device 102 is located is the user's home and the present time is morning, the server 201 may preferentially select a weather application or a news application that is frequently used based on the user's profile under the corresponding condition. As still another example, when the location where the speech recognition device 102 is located is an office, the server 201 may preferentially select a meeting application that the user frequently utilizes in his/her office. As still another example, when the speech recognition device 102 is the product displayed in an offline store, the server 201 may select only the pre-assigned applications (e.g., demo version application), based on the attribute of a location that is the public place, regardless of personal information. For another example, for the purpose of displaying applications having the different number on the display, the server 201 may preferentially select the applications based on the location at which the speech recognition device 102 is located, a user ID, or the type of an electronic device.

According to an embodiment of the disclosure, the server 201 may execute applications supported by the speech recognition device 102 using the AR application 530 and may perform a function for visually displaying content in the AR mode via the wearable device 101-1 or the user terminal 101-2.

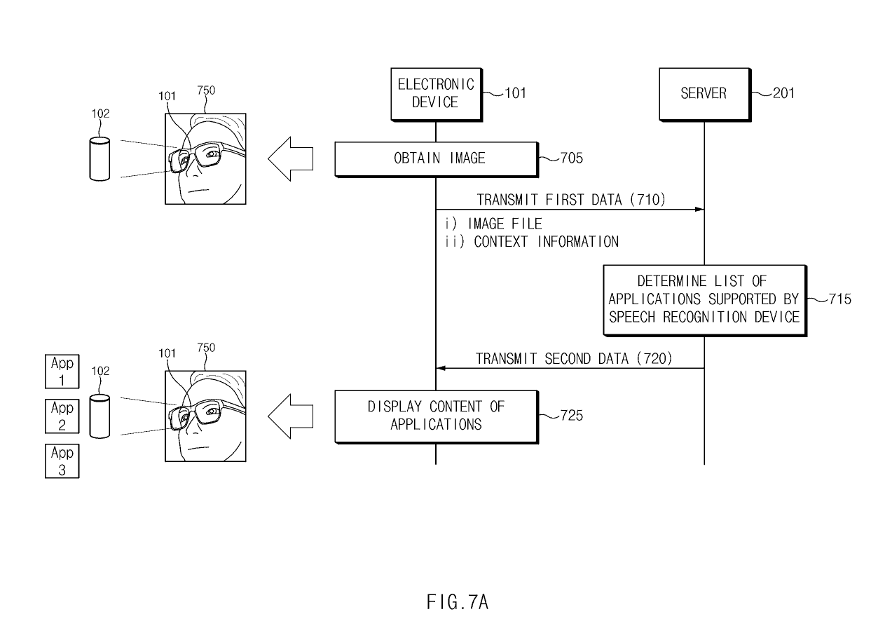

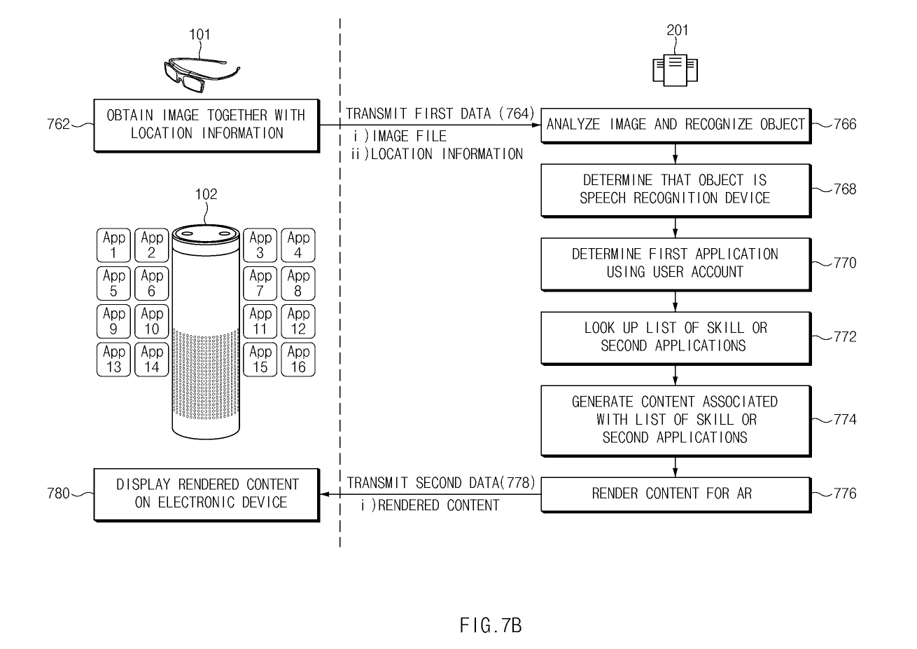

FIG. 7A illustrates an operation flowchart for displaying content of applications supported by a speech recognition device according to embodiments of the disclosure.

Referring to FIG. 7A, the electronic device 101 may refer to the wearable device 101-1 or the user terminal 101-2 coupled to the wearable device 101-1.

In operation 705, the electronic device 101 may obtain an image. According to an embodiment of the disclosure, the image may be at least one of a still image or a video. According to an embodiment of the disclosure, the electronic device 101 may obtain the image based on a specified condition.

For example, when a user 750 stares at the speech recognition device 102 in a state where the electronic device 101 (e.g., the wearable device 101-1) is worn on a part of the body of the user 750, the electronic device 101 may determine that the motion of the electronic device 101 is not detected. When the motion is not detected during a specified threshold time, the electronic device 101 may obtain an image in the direction in which the user 750 is looking via a camera (e.g., 320 in FIG. 3).

As another example, when the amount of change or movement of the preview images obtained via the camera is less than the specified threshold value, the electronic device 101 may obtain the image.

As still another example, when the electronic device 101 includes an eye detection module, the electronic device 101 may detect the direction of the user's gaze and may obtain an image of the detected direction.

As still another example, the electronic device 101 may obtain the image based on at least one of a separate user utterance or a separate user input for obtaining an image. For example, the user input may include at least one of a gesture or finger pointing sensed by a camera or a sensor.

As still another example, when the wearable device 101-1 is worn on a part of the user's body while the user terminal 101-2 is coupled to the wearable device 101-1, the user terminal 101-2 may trigger the AR mode and may detect an event associated with the execution of an application stored in the speech recognition device 102 in the AR mode. In an event associated with the execution of an application, the electronic device 101 may obtain an image based on at least one of a case where a user input to execute an application is received, a case where a call is received, a case where a message is received, a case where an alarm event occurs, a case where a schedule event occurs, a case where wireless communication (e.g., Wi-Fi) is connected or disconnected, a case where a battery level is less than a threshold value, a case where permission or restriction to use data occurs, a case where there is no response of an application, or a case where an application is terminated abnormally.

In operation 710, the electronic device 101 may transmit first data including the image and context information to the server 201. For example, the context information may include at least one of the location information of the electronic device 101, information about a time at which the image is obtained, or the user account information of the electronic device 101.

In operation 715, the server 201 may determine the list of applications supported by the speech recognition device 102 based on the first data. For example, the server 201 may recognize that the subject included in the image is the speech recognition device 102 by analyzing the image included in the first data. The server 201 may determine the list of applications supported by the speech recognition device 102 recognized based on context information included in the first data.

In operation 720, the server 201 may transmit second data including the list of applications to the electronic device 101.

In operation 725, the electronic device 101 may display the content of applications supported by the speech recognition device 102, via a display (e.g., 160-1 or 160-2 of FIG. 2) in the AR mode based on the received second data. For example, the electronic device 101 may convert the content of applications from 2-dimensional (2D) content to 3-dimensional (3D) content, which corresponds to the left eye and the right eye of a user, and may display the converted content in the AR mode. According to an embodiment of the disclosure, the electronic device 101 may also either display the content of applications without a user utterance or may display the content of applications in response to a user utterance (e.g., “Hi, Bixby”) for calling the speech recognition device 102.

FIG. 7B illustrates another operation flowchart for displaying content of applications supported by a speech recognition device according to embodiments of the disclosure.

FIG. 7B illustrates a flowchart of an operation of transmitting data between the wearable device 101-1 and the server 201. However, according to another embodiment, the operation flowchart may be applied similarly to data transmission between the wearable device 101-1 and the user terminal 101-2, or between the user terminal 101-2 and the server 201.

Referring to FIG. 7B, in operation 762, the electronic device 101 may obtain an image or a video. For example, the image or the video may include the image of the speech recognition device 102. The electronic device 101 may obtain location information of the electronic device 101 together with the image or the video. For example, the location information may be obtained based on at least one of a GPS, A-GPS, GNSS, cell ID, UWB, LiFi, BT, a depth sensor, an ultrasonic sensor, geo-fence, cellular, or Wi-Fi.

In operation 764, the electronic device 101 may transmit image data (or video data) and first data including location information to the server 201.

In operation 766, the server 201 may analyze the image using the image data and recognize the object included in the image based on the analysis result. For example, the server 201 may analyze the image via the image processing module 520 of FIG. 5.

In operation 768, the server 201 may determine that the recognized object is the speech recognition device 102 of the user (e.g., the user 750 of FIG. 7A).

In operation 770, the server 201 may select a first application of the speech recognition device 102 using a user account DB (e.g., 560 of FIG. 5) of the recognized speech recognition device 102. For example, when the speech recognition device 102 is an AI speaker of a specific manufacturer, the server 201 determines a user account (e.g., a subscriber account for receiving a service of the corresponding product or manufacturer) for using the service of the corresponding AI speaker and may select the first application associated with the determined user account. For example, the first application may manage one or more skills or a second application (e.g., associated with Apps 1, 2, . . ., 16 adjacent to the speech recognition device 102 of FIG. 7B) or may provide one or more of the display-related functions to the display of the electronic device 101. To this end, the first application may provide the function associated with one or more of determination whether the skill or the second application is available, recommendation, registration, update, user preference, list management, preference, or priority processing.

In operation 772, the server 201 may look up the skill list associated with the selected first application or the list of second applications. The skill may include a software module or specific information (e.g., a user or device ID, location information, price, manual, guide, advertisement, demo content) that includes at least part of functions for performing the function corresponding to the second application. According to an embodiment of the disclosure, when the server 201 determines the skill list or the list of second applications, the server 201 may determine the skill list or the list of second applications based on determination whether each skill or each of the second applications is available, whether each skill or each of the second applications is recommended, whether each skill or each of the second applications is selected by a user, or a combination thereof. For example, the list may include only one or more skills or only the second application, which is selected (or set) to be utilized by the user, from among a plurality of skills or the second applications which are associated with the first application. For example, the default skill or second application, which is specified to be used by the manufacturer by default, may be included in the list. For example, one or more skills or the second application, which are specified to be used by the manufacturer or the user, may be included in the first list. One or more skills or the second application, which are not specified to be used, may be included in the second list. In this case, the first list may be preferentially displayed in the electronic device 101, and the second list may be displayed via the electronic device 101 in response to a user input. The selected skill or second application thereof may then be moved to the first list. In operation 774, the server 201 may generate the content of the determined list. For example, the content may include at least one of a text, an image, a video, an icon, or a symbol for displaying the list of skills or second applications.

In an embodiment of the disclosure, when a user provides a voice command through the speech recognition device 102, there is a need for the name of the app or skill. In this case, the names of the apps or skills may be displayed in the wearable device 101-1 such that a user is capable of easily providing the voice command.

According to an embodiment of the disclosure, the server 201 may generate content based on at least one of the category, number, priorities, or usage histories of skills or second applications.

In operation 776, the server 201 may render the content generated such that the skill, the functions of second application, or the list of applications may be displayed in an AR environment.

In operation 778, the server 201 may transmit second data including the rendered content to the electronic device 101.

In operation 780, the electronic device 101 may display the rendered content via a display in the AR environment.

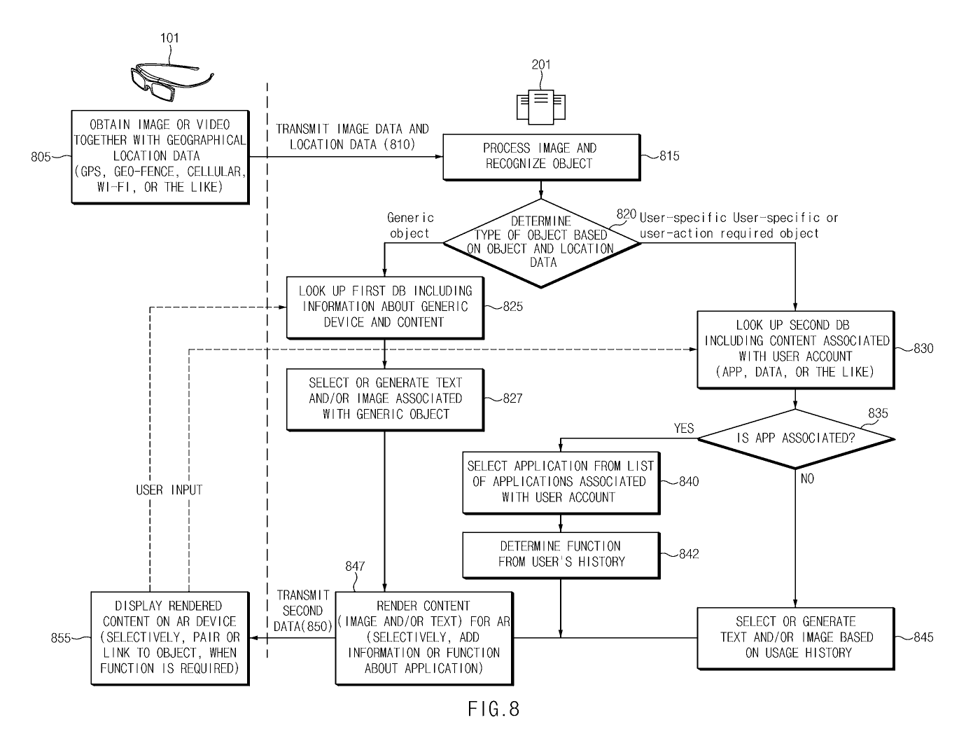

FIG. 8 illustrates an operation flowchart for determining an application list based on a type of speech recognition device according to embodiments of the disclosure.

Referring to FIG. 8, the server 201 may recognize the speech recognition device 102 based on image data and may determine the type of the speech recognition device 102 based on location information. For example, the type of the speech recognition device 102 may include a personal device and a generic device. The personal device may refer to a device in which a personal user account is registered. The generic device may refer to a device in which a plurality of user accounts are registered or in which a generic account is registered.

In operation 805, the electronic device 101 (e.g., the wearable device 101-1 or the user terminal 101-2) may obtain an image and location information of the electronic device 101. According to an embodiment of the disclosure, the electronic device 101 may measure a location based on at least one of a GPS, A-GPS, GNSS, cell ID, UWB, LiFi, BT, a depth sensor, an ultrasonic sensor, geo-fence, cellular, or Wi-Fi. According to another embodiment, the electronic device 101 may obtain the location information of the electronic device 101 based on the network information of the network to which the electronic device 101 is connected. According to another embodiment, in operation 805, the electronic device 101 may obtain time information using the image and a timer mounted in the electronic device 101, or the network information of the connected network. According to another embodiment, in operation 805, the electronic device 101 may obtain one or more of the location information of the electronic device 101, the time information, or user utterance information together with the image.

In operation 810, the electronic device 101 may transmit first data. According to an embodiment of the disclosure, the first data may include image data and the location information of the electronic device 101. According to an embodiment, when the electronic device 101 receives a user utterance, the first data may further include user utterance information. According to another embodiment, the first data may include at least one of the location information or the user utterance information.

According to another embodiment of the disclosure, the first data may include the image, the location information of the electronic device 101, and the time information. According to another embodiment, the first data may include one or more of the location information of the electronic device 101, the time information, or the user utterance information, together with the image.

In operation 815, the server 201 may process an image included in the first data and may recognize that an object included in the image is the speech recognition device 102.

In operation 820, the server 201 may determine the recognized type of the speech recognition device 102 based on at least one of location information (or, location data) or user utterance information. For example, when the location of the electronic device 101 is the user's private home, the server 201 may identify that the speech recognition device 102 is a personal device (user-specific or user action required object). For example, the personal device may be a device that is owned by the user of the electronic device 101 or is associated with the user of the electronic device 101. As another example, when the location of the electronic device 101 is a generic space, such as an office or an offline store, the server 201 may identify the speech recognition device 102 as a generic device. For example, the generic device may be a device that is not owned by the user of the electronic device 101 or is not associated with the user of the electronic device 101 or may be a device that provides unspecified users with one or more services in common. As still another example, when the user utterance information included in the first data corresponds to the pre-registered user utterance information (e.g., a wake-up utterance pre-specified by a user or authentication-related information), the server 201 may determine the speech recognition device 102 as a personal device. According to another embodiment, in addition to the location information, the server 201 may determine the type of the speech recognition device 102 based on usage history. According to another embodiment, the server 201 may determine the type of the speech recognition device 102 based on one or more of location information, time, and user utterance information.

When the speech recognition device 102 is a generic device, in operation 825, the server 201 may look up a first DB including generic acknowledgement, generic application, information about the generic device, and generic device-dedicated content. According to an embodiment of the disclosure, the first DB may include a first application group corresponding to a specified place (e.g., an office or an offline store). For example, the first application group may include an application or a skill that provides the function (e.g., meeting proceeding, schedule management, price information, how to use, promotion information, or demo content inquiry) associated with the specified place. According to an embodiment, the first DB may provide a function (e.g., weather, traffic, radio, or time notification) not requiring user authentication, information about the generic device, or generic content (e.g., an advertisement image, advertisement video, or free audio streaming). For example, the first DB may include a default application of the speech recognition device 102 or default content or may include a default application and default content.

According to an embodiment of the disclosure, the server 201 may use time information of the first data to look up the first DB including information and content of the generic device. For example, among the default application or the default content of the speech recognition device 102, the server 201 may look up the default application and the default content or may determine priority, based on the received time information.

According to another embodiment, the server 201 may use time and place information of the first data to look up the first DB including information and content of the generic device.

According to another embodiment, the server 201 may use one or more of time information, location information, or user utterance information of the first data to look up the first DB including the information and content of the generic device.

In operation 827, the server 201 may generate the content (e.g., an image and/or a text) of the generic device. For example, the server 201 may look up a list of skills, applications, or pieces of content from the first DB and may generate a display candidate content (e.g., a text or an image) to represent the found list. For example, the display candidate content may include a text or an image associated with the display order or display content related to the application, skill, and content to be displayed in the found list.

When the speech recognition device 102 is a personal device, in operation 830, the server 201 may look up the second DB including the content associated with the user account. The second DB may include a second application group corresponding to a user account associated with the speech recognition device 102. The second application group may include skills or applications selected or registered (or installed) by the user.

To this end, the server 201 may identify whether there is a user account associated with the speech recognition device 102. For example, the server 201 may identify whether the user account of the recognized speech recognition device 102 is stored in the user account DB 560. In this case, the server 201 may identify whether the user account associated with the speech recognition device 102 is present in the user account DB 560, using the user account information of the electronic device 101 included in the first data. When the user account associated with the speech recognition device 102 is present, the server 201 may generate a list of one or more of applications, skills, or pieces of content, based on the second DB.

In operation 835, the server 201 may determine whether one or more of the reception in operation 810 of the first data, the user input received in operation 830, or a usage history is associated with a specific application or skill. For example, the function may be assigned or selected by the reception in operation 810 of the first data or a voice signal or user gesture from the user input received in operation 835. For example, according to an embodiment, the server 201 may specify or select a function based on usage history. For example, the server 201 may specify or select the function based on usage history together with a voice command or a user gesture input. Whether an application or skill for supporting the function is required may be determined based on the specified or selected function.

When it is determined that a user account is associated with the specific application or skill, in operation 840, the server 201 may select an application from the list of applications associated with the user account. For example, the server 201 may determine one or more applications or skills associated with the reception in operation 810 of the first data, the user input received in operation 830, or the usage history, from the list of applications associated with the user account. For example, the server 201 may determine the list of applications to be displayed on the display of the electronic device 101 based on at least one of the usage history, the preferences set by the user, or the user's schedule.

In operation 842, the server 201 may determine the function of the application from the user's history. According to an embodiment of the disclosure, the server 201 may determine the function provided by the determined application or skill from the user history. The functions may be one or more functions provided by the application. The functions may be determined by the user's history or the execution states of the functions may be determined. For example, when the determined application is a music player, the server 210 may determine information of a playback state, whether to set continuous playback, a list of pieces of content to be played continuously, a detailed description (e.g., a composer, an album name, or a track name) of the selected music, or the like, based on the usage history and may determine functions associated with selection, inquiry, and playback of information. In this case, functions to be controlled through a user interface (UI) associated with the application may be determined. For example, when the determined application is a music player, the music playback function may be performed automatically from a point in time when music playback is stopped using a playback state, in which music has been most recently played, based on the usage history.

When one or more of the reception in operation 810 of the first data, the user input received in operation 830, or the usage history are not associated with a specific application or skill, in operation 845, the server 201 may generate display candidate content associated with an application, skill, or content to be displayed on the display of the electronic device 101 based on the usage history of the speech recognition device 102.

For example, the display candidate content may determine the text or image associated with the display order, display content, a UI, or the like associated with the application, skill, content to be displayed in the found list, based on the usage history (e.g., last usage history, usage frequency of function) and then may include the text or image. For example, the display candidate content may be an image or content playback screen of the application associated with a specific function.

In operation 847, the server 201 may render the AR content generated such that the function of the skill or application or the list of applications is capable of being displayed in an AR environment. For the purpose of displaying the display candidate content on the display of the electronic device 101, the AR content may be one of an image, video, or a 3D object generated by applying one or more arithmetic operations of object creation, shape, location, size, movement, rotation, color and transparency.

In operation 850, the server 201 may transmit second data including the rendered content to the electronic device 101.

In operation 855, the electronic device 101 may display the content of applications via the display based on the second data in the AR environment. According to an embodiment of the disclosure, the AR content of the second data may be displayed in conjunction with an image of the speech recognition device 102 included in the first data. For example, the AR content of the second data may be generated by the server 201 after being continuously updated based on the image change of the first data in operation 847. In this case, the server 201 may determine and generate the size, location, rotation angle, shearing, brightness, and transparency of the AR content to be displayed, based on the image size and distance information of the speech recognition device 102, in advance. Accordingly, the server 201 may continuously generate the AR content in association with the location or size of the image of the speech recognition device 102 in the image of the first data and may include the AR content in the second data to transmit the second data. For example, the AR content of the second data may be the reference AR content generated by the server 201 in operation 847. In this case, the server 201 may include and transmit the 3D model information of a specific standard (the normalized size, color, and rotation angle) as the AR content, to the second data. The electronic device 101 may determine and change the size, location, rotation angle, shearing, brightness, and transparency of the AR content to be displayed based on the received image size and distance information of the speech recognition device 102, in advance. Accordingly, the electronic device 101 may continuously change the AR content in association with the location or size of the image of the speech recognition device 102. Accordingly, when context such as a voice command, gesture recognition, function change, or the like occurs, the server 201 may change the AR content or may newly generate AR content.

According to an embodiment of the disclosure, the electronic device 101 may receive a user input to select the application, based on the content of the displayed applications. For example, the electronic device 101 may receive a user utterance input via the speech recognition device 102, or may receive a user input to select an input device (e.g., the input device 450 of FIG. 4) included in the electronic device 101. The electronic device 101 may transmit the received user input to the server 201. The server 201 may perform operation 825 to operation 850 based on the received user input.

According to an embodiment of the disclosure, the server 201 may specify or select the function in response to a voice signal or a user gesture in the reception in operation 810 of the first data or the user input in operation 835. In this case, in operation 840, the application or skill associated with the function may be selected. In operation 842, one or more UIs associated with the function supported by the selected application or skill may be determined. For example, when a user enters a voice command or a user gesture associated with music playback, the server 201 may select the application or skill associated with the music playback from a list and may determine pieces of music content capable of being played from the electronic device 101, the server 201, and the memory of the external electronic device to generate the list.

According to an embodiment of the disclosure, the server 201 may specify or select a function based on the usage history. For example, in operation 835, the server 201 may detect that the recently used function is associated with an audio playback application based on usage history. In operation 840, the server 201 may select an application or skill associated with the audio playback most recently used by the user from the list. In operation 842, the UI capable of controlling the function associated with the playback state (e.g., one or more of a content name, a play state, a volume state, a channel name, URL, content description) stored in conjunction with the selected application or skill may be determined.

According to an embodiment of the disclosure, the server 201 may specify or select the function based on usage history together with a voice command or a user gesture input. For example, when the user enters a voice command or gesture recognition in conjunction with a food order in operation 835, the server 201 may determine that the voice command or gesture recognition is associated with a food order application. In operation 840, the server 201 may select food order applications or skills from the list. In operation 842, the server 201 may determine the priorities of food order applications or skills, using the usage history (e.g., one or more of most recently used time or the order frequency) and may generate the list based on the priorities. In this case, the server 201 may select an application or a skill based on the continuous voice command or gesture recognition and may determine one or more foods using the history or preference, in which the food has been recently ordered, based on the usage history in conjunction with the selected application or skill. For convenience of description, the server 201 may be described as a single server. However, the server 201 may be configured such that a plurality of servers or external devices are operatively interlocked with one another. For example, the user account DB, the first DB, and the second DB of the speech recognition device 102 are included in one or more servers, and may also exchange necessary content with the server 201 for image processing via wired or wireless communication. For example, a part of functions of the server 102 may be processed by the electronic device 101, and other functions may be processed through distributed processing via wired or wireless communication.

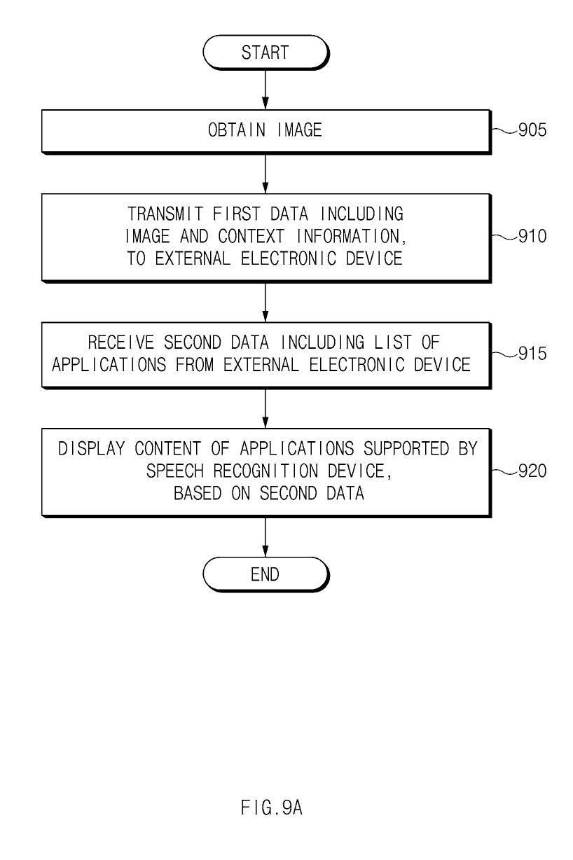

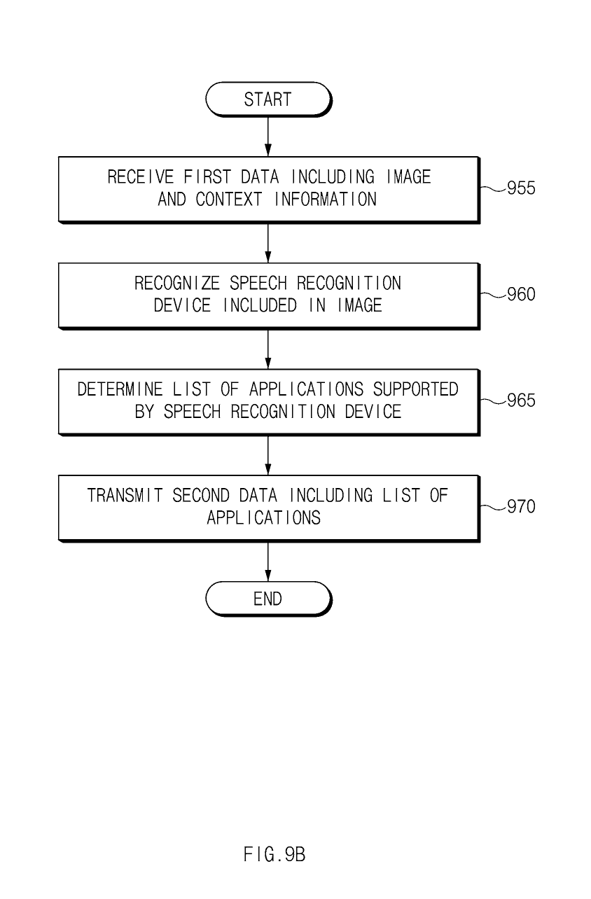

FIG. 9A is a flowchart of operations of an electronic device for displaying content of applications according to embodiments of the disclosure. The operations illustrated in the operation flowchart may be performed by the electronic device 101 or may be performed by a component (e.g., the processor 330 of FIG. 3 or the processor 420 of FIG. 4) of the electronic device 101.

Referring to FIG. 9A, the electronic device 101 may be the wearable device 101-1 or the user terminal 101-2. When the electronic device 101 is the user terminal 101-2, the user terminal 101-2 may perform operations of the operation flowchart while being coupled to the wearable device 101-1 or may perform operations independently of the wearable device 101-1.

In operation 905, the electronic device 101 may obtain the image including the speech recognition device 102. According to an embodiment of the disclosure, when specified condition is detected, the electronic device 101 may obtain the image via a camera.

In operation 910, the electronic device 101 may transmit first data including the image and context information to an external electronic device (e.g., the server 201 of FIG. 1). When the electronic device 101 corresponds to the wearable device 101-1, the wearable device 101-1 may transmit the first data to the user terminal 101-2.

In operation 915, the electronic device 101 may receive second data including the list of applications supported by the speech recognition device 102 from the external electronic device.

In operation 920, the electronic device 101 may display the content of applications supported by the speech recognition device 102 based on the second data.

FIG. 9B is a flowchart of operations of a server for determining an application list according to embodiments of the disclosure. The operations illustrated in the operation flowchart may be performed by the server 201 or may be performed by a component (e.g., the processor 502 of FIG. 5) of the server 201.

Referring to FIG. 9B, in operation 955, the server 201 may receive first data including image and context information from the electronic device 101. For example, the context information may include at least one of the location information, time information, or the user account information.

In operation 960, the server 201 may analyze the image included in the first data and may recognize the speech recognition device 102 included in the image based on the analysis result. The server 201 may analyze the image through the image processing module 520 and the external server 202. For example, the server 201 may determine that the primary category of the subject included in the image is an electronic device, the secondary category is an AI speaker, and the model name is “xxxx”.

In operation 965, the server 201 may determine the list of applications supported by the speech recognition device 102. For example, the application included in the list of applications may include an application supporting at least one of a native mode or a plugged-in mode. According to an embodiment of the disclosure, the server 201 may determine at least one of the category, number, or priorities of applications, based on information stored in the context DB 550.

In operation 970, the server 201 may transmit second data including the list of applications to the electronic device 101.

Although not illustrated in FIG. 9B, the server 201 may generate information for rendering the content of applications in an AR mode. As another example, the server 201 may transmit only the list of applications, and the electronic device 101 may render the content of applications in the AR mode based on the received list of applications. The rendered AR content may be displayed on the display of the electronic device 101. For example, the rendered AR content may be displayed on the display of the electronic device 101 in conjunction with the location of the speech recognition device 102.

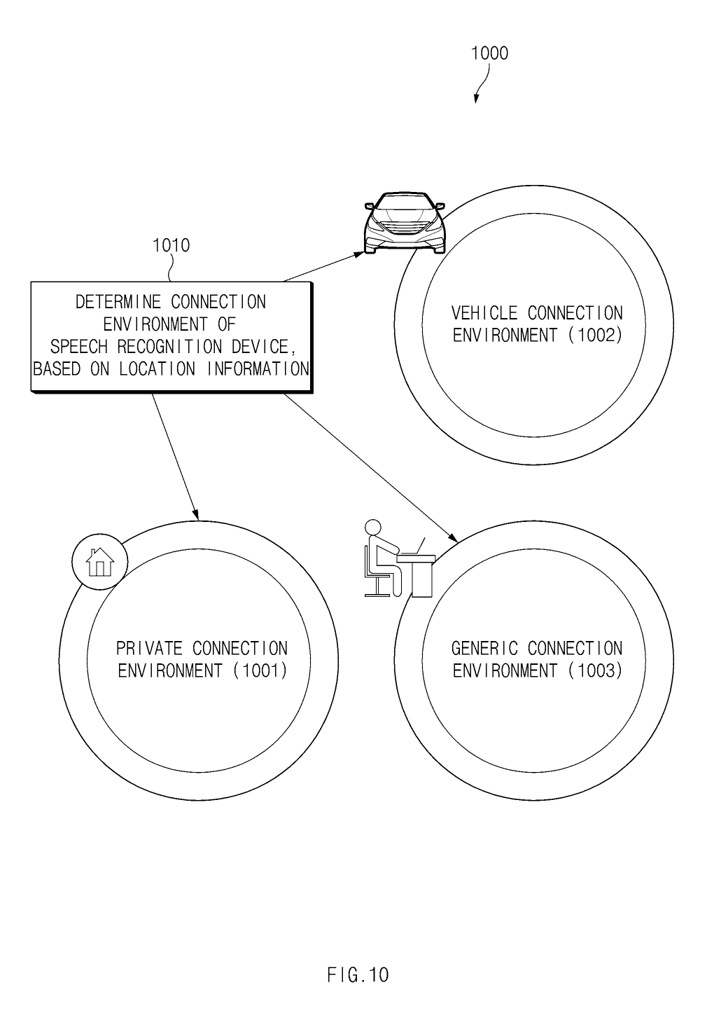

FIG. 10 illustrates a connection environment in which a speech recognition device is included according to embodiments of the disclosure.

According to an embodiment, the server 201 may determine applications which are to be recommended to a user based on a connection environment 1000 in which the speech recognition device 102 is included. The electronic device 101 may display the content of applications determined by the server 201.

Referring to FIG. 10, in operation 1010, the server 201 may determine the type of the connection environment 1000 of the speech recognition device 102 based on the location information of the electronic device 101. The location information may include at least one of location information measured by the electronic device 101 or network information of a network to which the electronic device 101 is connected. For example, the network information may include at least one of the type of a network, the speed of a network, the connectivity of a network, the capability of a network, the service availability of a network, or information of an edge server. The connection environment 1000 may include a private connection environment 1001, a vehicle connection environment 1002, and a generic connection environment 1003.

According to an embodiment of the disclosure, the private connection environment 1001 may refer to the environment in which the speech recognition device 102 is placed in a user's home or connected to a private Internet network. In the private connection environment 1001, the server 201 may recommend a user-specific application (e.g., a personal schedule application or a personal message application), based on user account information. In this case, the server 201 may set the priority of the user-specific application to be high.

According to an embodiment of the disclosure, the vehicle connection environment 1002 may refer to an environment in which the speech recognition device 102 is arranged inside a vehicle or handover of the connected network occurs frequently. In the vehicle connection environment 1002, the server 201 may recommend an application (e.g., a navigation application or a map application) according to the change of a network state. According to an embodiment, the server 201 may set the priority of an application (e.g., a video streaming service application), which is frequently disconnected in the vehicle connection environment 1002, so as to be low.

According to an embodiment of the disclosure, the generic connection environment 1003 may refer to an environment in which a plurality of users utilize the speech recognition device 102. For example, the speech recognition device 102 may be located inside an office or an offline store. In the generic connection environment 1003, the server 201 may set the priorities of applications (e.g., meeting application and schedule application) associated with a business or applications for product demonstrations so as to be high. As another example, when the speech recognition device 102 is installed in an office, the server 201 may set the priority of an application (e.g., game application) restricted in the office to be low. As still another example, when the speech recognition device 102 is installed in an offline store, the server 201 may set the priority of an application associated with an advertisement, a coupon, or shopping, so as to be high.

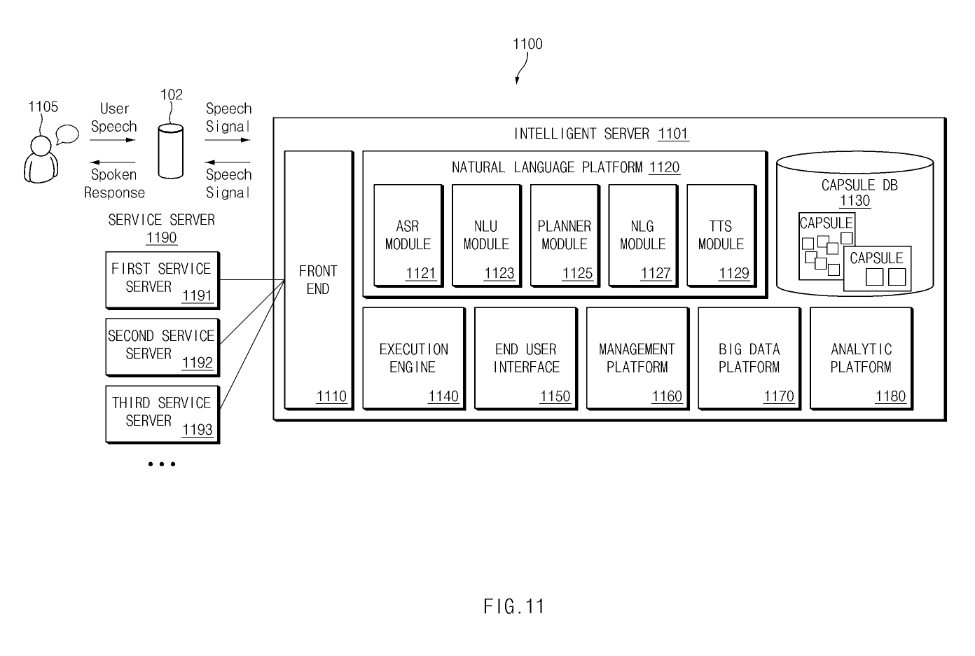

FIG. 11 is a block diagram of an AI system for executing a speech recognition device according to embodiments of the disclosure.

Referring to FIG. 11, a user 1105 may execute the speech recognition device 102 via a user utterance by referring to the content of the applications displayed by the electronic device 101. The speech recognition device 102 may provide a service corresponding to the user utterance via an AI system 1100. An intelligent server 1101 of FIG. 11 may be an entity independent of the server 201 of FIG. 1, or may be a server integrated with the server 201 of FIG. 1.

According to an embodiment of the disclosure, the intelligent server 1101 may receive information associated with a user utterance input (or user utterance) from the speech recognition device 102 via a communication network. According to an embodiment, the intelligent server 1101 may change the data associated with the received voice input to text data. According to an embodiment, the intelligent server 1101 may generate a plan for performing a task corresponding to a user utterance input based on the text data.

According to an embodiment of the disclosure, the plan may be generated by an AI system. The AI system may be a rule-based system, or may be a neural network-based system (e.g., a feedforward neural network (FNN) or a recurrent neural network (RNN)). Alternatively, the AI system may be a combination of the above-described systems or an AI system different from the above-described system. According to an embodiment, the plan may be selected from a set of predefined plans or may be generated in real time in response to a user request. For example, the AI system may select at least one plan of a plurality of predefined plans.

According to an embodiment of the disclosure, the intelligent server 1101 may transmit the result calculated based on the generated plan to the speech recognition device 102 or may transmit the generated plan to the speech recognition device 102. According to an embodiment, the speech recognition device 102 may output the result calculated based on the plan via voice.

The intelligent server 1101 according to an embodiment may include a front end 1110, a natural language platform 1120, a capsule DB 1130, an execution engine 1140, an end UI 1150, a management platform 1160, a big data platform 1170, and an analytic platform 1180.

According to an embodiment of the disclosure, the front end 1110 may receive a voice input received from the speech recognition device 102. The front end 1110 may transmit a response corresponding to the voice input.

According to an embodiment of the disclosure, the natural language platform 1120 may include an automatic speech recognition (ASR) module 1121, a natural language understanding module (NLU) module 1123, a planner module 1125, a natural language generator module (NLG) module 1127, and a text to speech module (TTS) module 1129.

According to an embodiment of the disclosure, the ASR module 1121 may convert the voice input received from the speech recognition device 102 to text data. According to an embodiment, the NLU module 1123 may grasp the intent of the user using the text data of the voice input. For example, the NLU module 1123 may grasp the intent of the user by performing syntactic analysis or semantic analysis. According to an embodiment, the NLU module 1123 may grasp the meaning of words extracted from the voice input by using linguistic features (e.g., syntactic elements) such as morphemes or phrases and may determine the intent of the user by matching the grasped meaning of the words to the intent.

According to an embodiment of the disclosure, the planner module 1125 may generate the plan by using the intent and a parameter which are determined by the NLU module 1123. According to an embodiment, the planner module 1125 may determine a plurality of domains necessary to perform a task based on the determined intent. The planner module 1125 may determine a plurality of actions included in each of the determined plurality of domains based on the intent. According to an embodiment, the planner module 1125 may determine the parameter necessary to perform the determined plurality of actions or the result value output by the execution of the plurality of actions. The parameter and the result value may be defined as a concept associated with the specified form (or class). As such, the plan may include the plurality of actions and a plurality of concepts determined by the intent of the user. The planner module 1125 may determine the relationship between the plurality of actions and the plurality of concepts stepwise (or hierarchically). For example, the planner module 1125 may determine the execution sequence of the plurality of actions, which are determined based on a user's intent, based on the plurality of concepts. That is, the planner module 1125 may determine the execution sequence of the plurality of actions based on the parameters necessary to perform the plurality of actions and the result output by the execution of the plurality of actions. As such, the planner module 1125 may generate a plan including information (e.g., ontology) of the relationship between a plurality of actions and a plurality of concepts. The planner module 1125 may generate the plan using the information stored in the capsule DB 1130 storing a set of relationships between concepts and actions.

According to an embodiment of the disclosure, the NLG module 1127 may change the specified information into information in the text form. Information changed to the text form may be a form of a natural language utterance. The TTS module 1129 according to an embodiment may change information of the text form to information of a voice form.

According to an embodiment of the disclosure, the capsule DB 1130 may store information about the relationship between the actions and the plurality of concepts corresponding to a plurality of domains. For example, the capsule DB 1130 may store a plurality of capsules including a plurality of action objects (or action information) and concept objects (or concept information) of the plan. According to an embodiment, the capsule DB 1130 may store the plurality of capsules in the form of a concept action network (CAN). According to an embodiment, the plurality of capsules may be stored in the function registry included in the capsule DB 1130.

According to an embodiment of the disclosure, the capsule DB 1130 may include a strategy registry that stores strategy information necessary to determine a plan corresponding to a voice input. The strategy information may include reference information for determining a single plan when there are a plurality of plans corresponding to the voice input. According to an embodiment, the capsule DB 1130 may include a follow up registry that stores the information of the follow-up action for suggesting the follow-up action to the user in the specified context. For example, the follow-up action may include a follow-up utterance. According to an embodiment, the capsule DB 1130 may include a layout registry for storing layout information of the information output via the speech recognition device 102. According to an embodiment, the capsule DB 1130 may include a vocabulary registry that stores vocabulary information included in the capsule information. According to an embodiment, the capsule DB 1130 may include a dialog registry that stores information about dialog (or interaction) with the user.

According to an embodiment of the disclosure, the capsule DB 1130 may update the stored object via a developer tool. For example, the developer tool may include a function editor for updating an action object or a concept object. The developer tool may include a vocabulary editor for updating the vocabulary. The developer tool may include a strategy editor that generates and registers a strategy for determining the plan. The developer tool may include a dialog editor that creates a dialog with the user. The developer tool may include a follow up editor capable of activating the follow-up target and editing the follow-up utterance for providing a hint. The follow-up target may be determined based on the currently set target, the preference, or environment condition of the user.

According to an embodiment of the disclosure, the capsule DB 1130 may be implemented in the speech recognition device 102. That is, the speech recognition device 102 may include the capsule DB 1130 storing information for determining the action corresponding to the voice input.

According to an embodiment of the disclosure, the execution engine 1140 may calculate the result using the generated plan. According to an embodiment, the end UI 1150 may transmit the calculated result to the speech recognition device 102. As such, the speech recognition device 102 may receive the result and may provide the received result to the user 1105. According to an embodiment, the management platform 1160 may manage information used by the intelligent server 1101. According to an embodiment, the big data platform 1170 may collect the user's data. According to an embodiment, the analytic platform 1180 may manage the quality of service (QoS) of the intelligent server 1101. For example, the analytic platform 1180 may manage the component and processing speed (or efficiency) of the intelligent server 1101.

According to an embodiment of the disclosure, a service server 1190 may provide the speech recognition device 102 with a specified service (e.g., food order or hotel reservation). According to an embodiment, the service server 1190 may be a server operated by a third party. For example, the service server 1190 may include a first service server 1191, a second service server 1192, and a third service server 1193, which are operated by different third parties. According to an embodiment, the service server 1190 may provide the intelligent server 1101 with information for generating a plan corresponding to the received voice input. For example, the provided information may be stored in the capsule DB 1130. Furthermore, the service server 1190 may provide the intelligent server 1101 with result information according to the plan.

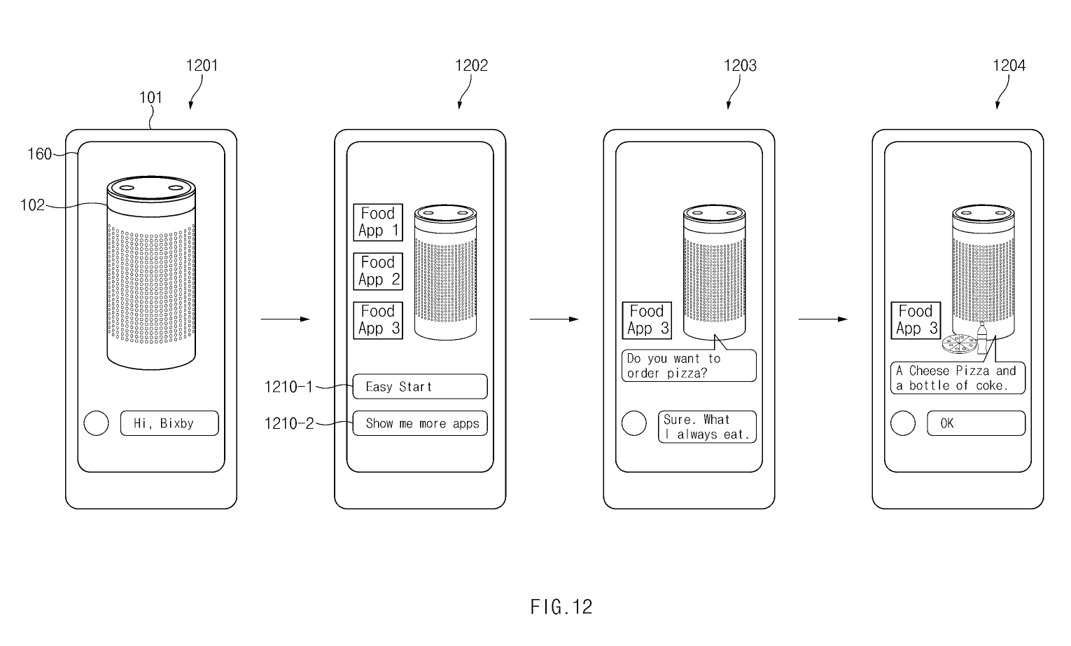

FIG. 12 illustrates a UI for displaying an application to be recommended to a user according to embodiments of the disclosure. The electronic device 101 illustrated in FIG. 12 may include the wearable device 101-1 or the user terminal 101-2, and the display 160 may include the displays 160-1 and 160-2 of FIG. 2.

Referring to FIG. 12, in operation 1201, the electronic device 101 may obtain an image of the speech recognition device 102. For example, when the motion is not detected during the specified critical time (e.g., 1 second), the electronic device 101 may obtain an image. As another example, the electronic device 101 may obtain the image in response to a user utterance (e.g., wake-up utterance or speech recognition reservation word utterance) for calling the speech recognition device 102.

In operation 1202, the electronic device 101 may display the list of applications supported by the speech recognition device 102 in an AR mode via the display 160. According to an embodiment, the server 201 may recommend the specified category or the predetermined number of applications to a user based on context information (e.g., information stored in the context DB 550 of FIG. 5). For example, when the location where the speech recognition device 102 is located is the user's home and the present time is evening, the electronic device 101 may display the content of food applications 1, 2, and 3 among the applications supported by the speech recognition device 102. As another example, when a user utterance (e.g., “I'm hungry”) indicating the user's state is received, the electronic device 101 may display the content of the food applications 1, 2, and 3.

According to an embodiment of the disclosure, when a user input (or user utterance) for a menu (e.g., 1210-2) indicating other applications is received, the electronic device 101 may display other applications in addition to the displayed applications.

According to an embodiment of the disclosure, when a user input (or user utterance) for a menu (e.g., 1210-1) for selecting applications (e.g., 1, 2, and 3) recommended in operation 1202 is received, in operation 1203, the electronic device 101 may display one application (e.g., the food APP 3) of the illustrated applications 1, 2, or 3. According to an embodiment, the server 201 may select the food APP 3 based on the user's usage history.

According to an embodiment of the disclosure, when a user utterance or user gesture for selecting the recommended food APP 3 is received, in operation 1204, the electronic device 101 may recommend a specified food (e.g., pizza or cola) which is specified by the application or which is specified based on usage history, from among the foods provided by the food APP 3 based on the user's usage history. The electronic device 101 may display an image of the recommended food on the display 160. In this case, when one of the recommended foods is selected by the user gesture, the electronic device 101 may display the text of a voice command for ordering the selected recommended food on the display of the electronic device 101, may generate a voice command for ordering the recommended food to output the voice command via the speaker of the electronic device 101, or may transmit a signal for ordering the recommended food, to the speech recognition device 102 via wired or wireless communication (Wi-Fi or BT). The result in which the speech recognition device 102 processes the order may be transmitted to the electronic device 101 or the server 201 via a voice output or the wired or wireless communication, and the result of processing the transmitted order may be recorded as information about a user account or usage history.

According to an embodiment of the disclosure, the electronic device 101 may apply a blur effect or a shadow effect to another image (or icon) other than the image of the recommended application (e.g., APP 3) or the image of the recommended food or may control the blur effect or the shadow effect to be displayed on the image of the speech recognition device 102, thereby providing visual effect in an AR environment.

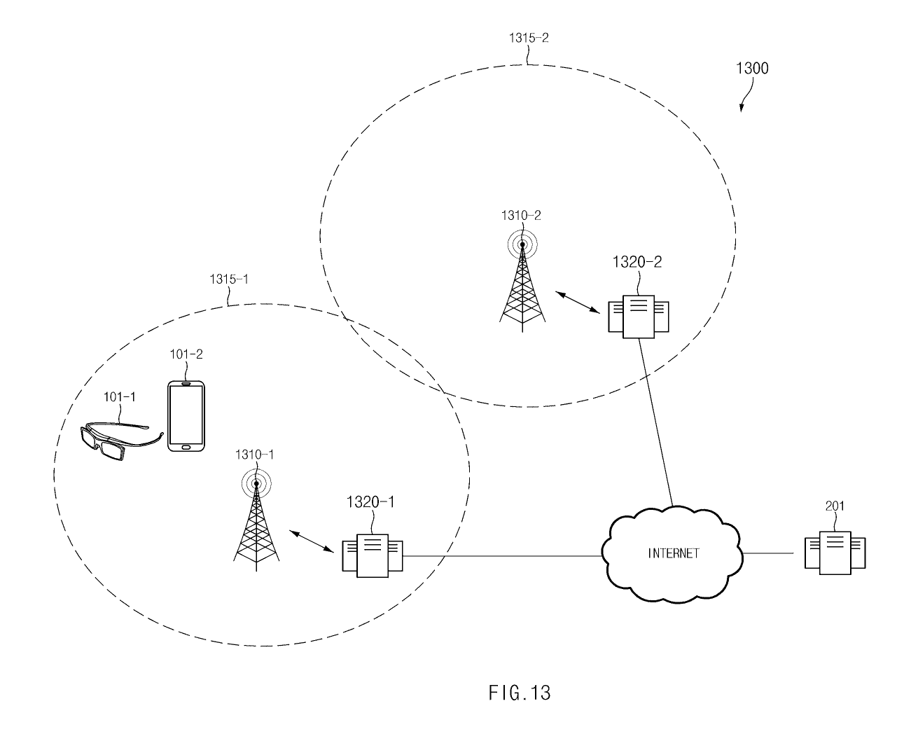

FIG. 13 illustrates a network environment including an edge server according to embodiments of the disclosure.

Referring to FIG. 13, a network environment 1300 (e.g., 100 of FIG. 1) may further include edge servers 1320-1 and 1320-2 between the electronic device 101 (e.g., the wearable device 101-1 or the user terminal 101-2) and the server 201. According to an embodiment of the disclosure, the edge servers 1320-1 and 1320-2 may include at least one of cloudlet, ad-hoc cloud, fog computing, cloud radio access network (C-RAN), MEC, or multi-access edge computing (MEC) defined in European telecommunications standards institute (ETSI). The number of edge servers illustrated in FIG. 13 is an example, and the number of edge servers is not limited to the example illustrated in FIG. 13.

According to an embodiment of the disclosure, the server 201 may identify the location of the electronic device 101 based on the information of the edge server to which the electronic device 101 is connected. For example, the first edge server 1320-1 may be connected to a first base station 1310-1 including a first cell 1315-1. The second edge server 1320-2 may be connected to a second base station 1310-2 including a second cell 1315-2. The first cell 1315-1 may include the user's home, and the second cell 1315-2 may include the user's office. When the electronic device 101 is located in the first cell 1315-1, the electronic device 101 may be connected to the first edge server 1320-1 via the first base station 1310-1. The server 201 may identify that the electronic device 101 is located in the first cell 1315-1 based on the information (e.g., identification information) of the first edge server 1320-1. According to an embodiment, the server 201 may receive information of the edge server (e.g., the first edge server 1320-1), to which the electronic device 101 is connected, from the electronic device 101 or a base station (e.g., the first base station 1310-1).

According to an embodiment of the disclosure, the server 201 may also receive the usage history information of the electronic device 101 or the speech recognition device 102 which is stored in the edge server (e.g., the first edge server 1320-1) to which the electronic device 101 is connected, from the electronic device 101 or the edge server to which the electronic device 101 is connected. Accordingly, different usage history information corresponding to the speech recognition device 102 may be stored for each edge server to which the electronic device 101 is connected. Alternatively, the electronic device 101 or the server 201 may store different usage history information for each edge server in compliance with an edge server to which the electronic device 101 is connected.

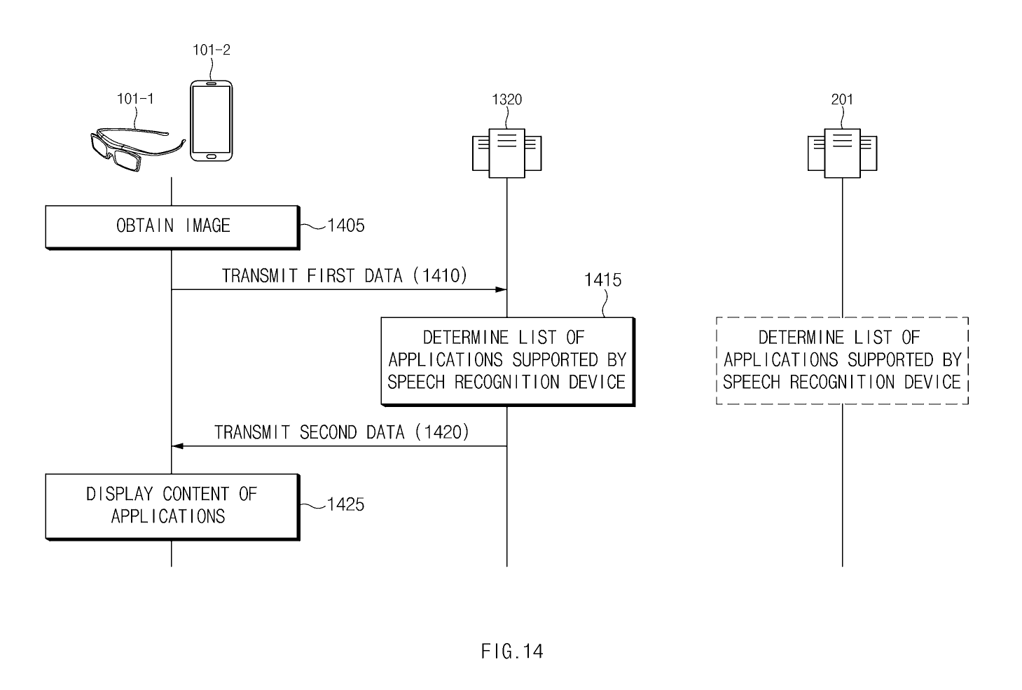

FIG. 14 illustrates an operation flowchart for determining an application list based on an edge server according to various embodiments of the disclosure.

Referring to FIG. 14, an edge server 1320 (e.g., the first edge server 1320-1 of FIG. 13) may be positioned at a location that is geographically closer to the electronic device 101 than the server 201. For example, the edge server 1320 may be positioned inside a base station (e.g., the first base station 1310-1 of FIG. 13) or near a base station. When the electronic device 101 requires low latency, the electronic device 101 may transmit or receive data to and from the edge server 1320 located at a geographically close location, without transmitting or receiving data to and from the server 201. The edge server 1320 may provide the electronic device 101 with low latency, high bandwidth, and real-time data transmission.

According to an embodiment of the disclosure, the edge server 1320 includes components the same as or similar to those of the server 201 and may perform a function the same as or similar to the function of the server 201. The edge server 1320 may include at least part of the components of the service module 510 of FIG. 5. For example, when the edge server 1320 includes the image processing module 520, the edge server 1320 may perform image analysis. When the edge server 1320 performs the image analysis, the burden of image processing of the user terminal 101-2 may be reduced and the data transmission time may be reduced compared to the server 201.

According to an embodiment of the disclosure, the performance of the service module included in the edge server 1320 may be lower than that of the service module 510 included in the server 201 due to the physical restriction. In this case, the edge server 1320 may transmit a request, which is difficult to process, from among requests (i.e., image processing and application determination) of the electronic device 101 to the server 201.

In operation 1405, the electronic device 101 (e.g., the wearable device 101-1 or the user terminal 101-2) may obtain an image including the speech recognition device 102.

In operation 1410, the electronic device 101 may transmit first data including the image and context information to the edge server 1320 positioned at a location that is geographically closer than the server 201. In this case, data transmission time may be reduced.

According to an embodiment of the disclosure, for the purpose of transmitting the first data including image and context information to the edge server 1320, the electronic device 101 may discover an edge server adjacent to the electronic device 101. In this case, the electronic device 101 may make a request for the access to the edge server using first network address information (e.g., a domain name address or a virtual private network gateway address). The server 201 (or a separate server) that manages the connection to the edge server may receive the request and may determine the second network address information capable of being accessed to the edge server adjacent to the electronic device 101. The electronic device 101 may communicate with the edge server corresponding to the determined second network address information using the determined second network address information. For example, the electronic device 101 may exchange data by directly accessing the corresponding edge server using the determined second network address information. Alternatively, an edge server access management server may relay data exchanged between the electronic device 101 and the edge server. Accordingly, even though the electronic device 101 uses the same first network address information based on the place where the speech recognition device 102 is used, the accessed edge server can be changed. The usage history or user profile, which is stored in the edge server or associated with the edge server, may vary depending on the result place.

In operation 1415, the edge server 1320 may determine the list of applications supported by the speech recognition device 102 based on the first data. For example, the edge server 1320 may recognize the speech recognition device 102 by analyzing image data and may determine the list of applications supported by the speech recognition device 102 based on location information of the electronic device 101.

In operation 1420, the edge server 1320 may transmit second data including the list of applications to the electronic device 101.

In operation 1425, the electronic device 101 may display the content of applications supported by the speech recognition device 102 via a display (e.g., 160-1 or 160-2 of FIG. 2) in the AR mode based on the received second data.

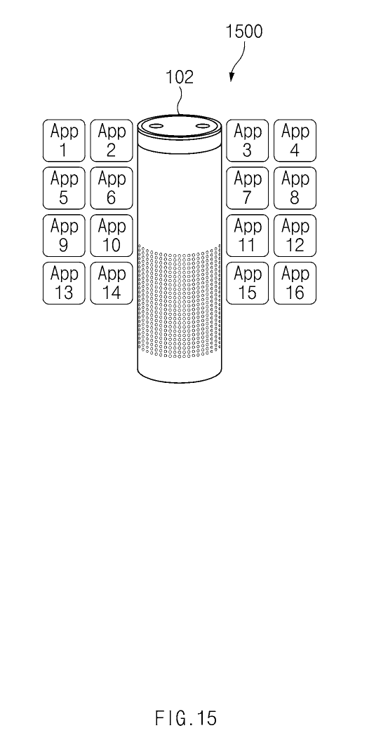

FIGS. 15 to 17 illustrate UIs including content in an AR environment according to embodiments of the disclosure.

Referring to FIG. 15, in an AR environment 1500, the electronic device 101 (e.g., the wearable device 101-1 or the user terminal 101-2) may display a UI indicating the speech recognition device 102 and a list of a plurality of applications (or skills) supported by the speech recognition device 102. For example, the speech recognition device 102 may be seen via a camera of the electronic device 101 or a see-through display, and the list of applications (e.g., App 1, App 2, . . . , App 16) may be displayed on a display. In an embodiment, the list may include the name of the applications and may include an icon additionally indicating the applications or additional information.

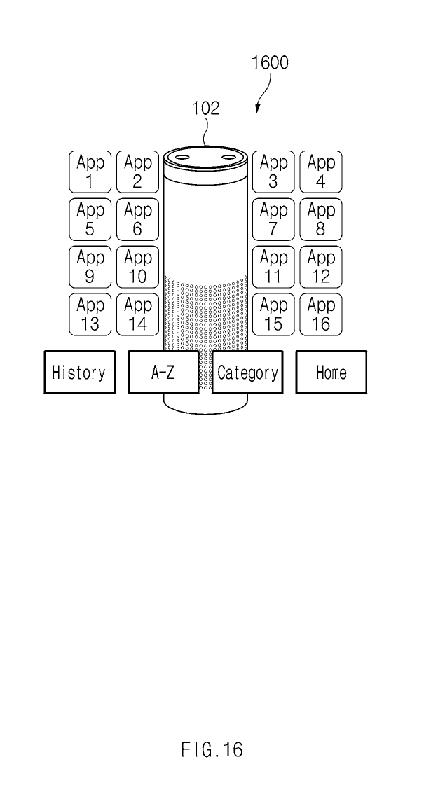

Referring to FIG. 16, in an AR environment 1600, the electronic device 101 may display additional buttons (e.g., 1, 2, 3, and 4) in addition to the speech recognition device 102 and the list of applications. For example, the buttons may provide an input means for displaying the list of applications (e.g., applications) based on the usage history or in alphabetical order. In another embodiment, one of the buttons may be used to display the applications for each category. In still another embodiment, the list of applications may include a plurality of pages. One of the buttons may be used to select one (e.g., a home screen) of a plurality of pages.

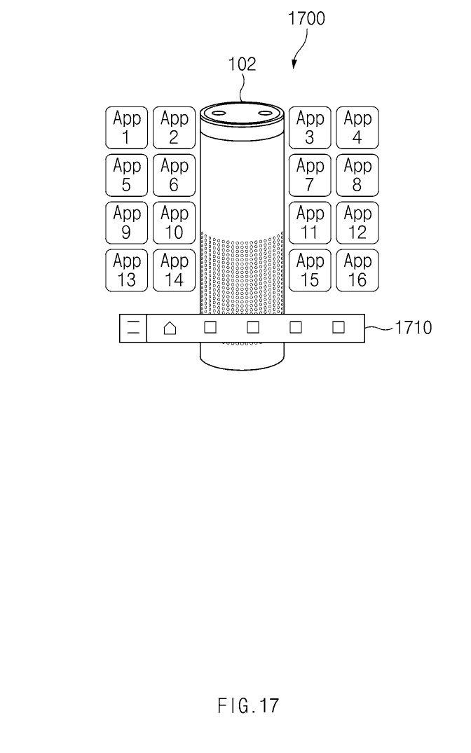

Referring to FIG. 17, in an AR environment 1700, the electronic device 101 may provide a plurality of pages including a list of applications. In this case, a user may scroll the pages using, for example, a swipe gesture. In this case, the electronic device 101 may further include a GUI 1710 for displaying currently displayed pages in addition to the speech recognition device 102 and the list of applications. In this case, when there is a home page, the GUI 1710 may include a symbol for displaying the home page. In the illustrated embodiment, six pages are present, and the home page is positioned at the second location from the left. Furthermore, the currently displayed page may be highlighted and displayed on the GUI.

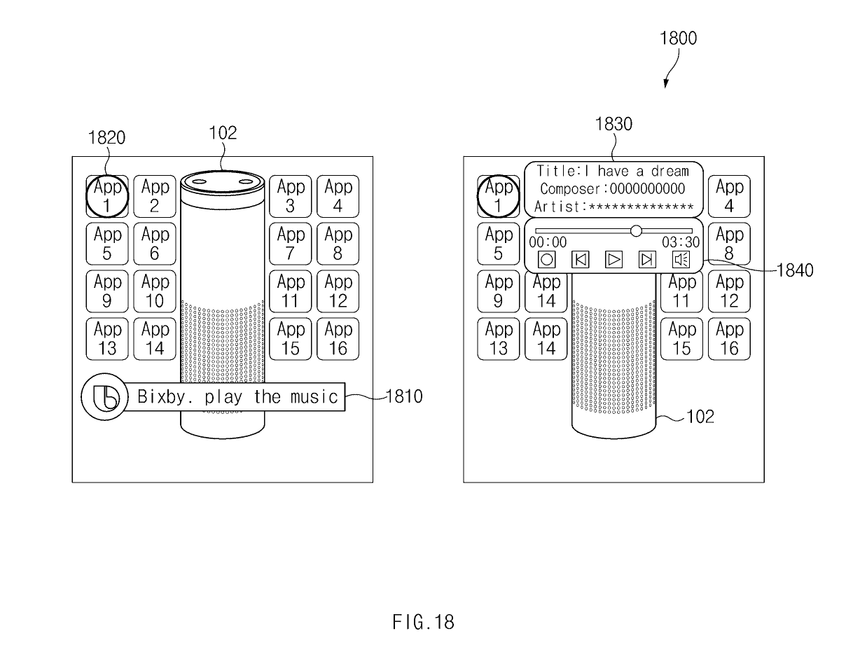

FIG. 18 illustrates another example of a UI for displaying AR content in an AR environment based on a user account according to various embodiments of the disclosure.

Referring to FIG. 18, in an AR environment 1800, the electronic device 101 (e.g., the wearable device 101-1 or the user terminal 101-2) may display a UI indicating the speech recognition device 102 and a list of a plurality of applications supported by the speech recognition device 102. In this case, an application “App 1” 1820 may be selected by the voice input or gesture recognition of a user. For example, when a wake-up utterance (“bixby”) and a voice command (“play the music”) are entered via voice to play the music, the application App 1 corresponding to the speech recognition command, which is recognized by the electronic device 101, the speech recognition device 102, or the server 201, may be selected among applications. At this time, text information 1810 corresponding to the recognized voice command or a graphic indicator 1820 indicating the selected application App 1 may be displayed together. For example, the application App 1 may be selected by a user gesture (e.g., a hand gesture, a display touch, or the like) among applications App 1 to App 16 to play the music. At this time, the graphic indicator 1820 indicating the selected application App 1 may be displayed together.

When the application is selected, the UI corresponding to the function of the application may be displayed in an AR mode based on usage history information or a user account. For example, when the application App 1 associated with music playback is selected, the control UI (e.g., a progress bar, an information display call button, a previous song selection button, a next song selection button, or audio volume adjustment button) corresponding to music information 1830 previously played and the function of the application App 1 may be rendered for AR and then displayed based on the usage history information or the user account so as to correspond to the speech recognition device 102.

As described above, according to embodiments of the disclosure, an electronic device (e.g., 101-1 or 101-2 of FIG. 1) may include a display (e.g., 360 of FIG. 3 or 460 of FIG. 4), a camera (e.g., 320 of FIG. 3 or 420 of FIG. 4), a wireless communication circuit (e.g., 370 of FIG. 3 or 490 of FIG. 4), a processor (e.g., 330 of FIG. 3 or 420 of FIG. 4) operatively connected to the display, the camera, and the wireless communication circuit, and a memory (e.g., 340 of FIG. 3 or 440 of FIG. 4) operatively connected to the processor. The memory may store instructions that, when executed, cause the processor to obtain an image including an external speech recognition-based AI device which is associated with an account of a user of the electronic device via the camera, transmit first data including the image and context information to an external electronic device (e.g., 101-2 or 201 of FIG. 1) via the wireless communication circuit, receive second data including a list including names of applications installed in an AI system including the AI device from the external electronic device via the wireless communication circuit, and display a GUI including the list via the display based on the second data so as to be adjacent to or overlapped with the AI device.

According to an embodiment of the disclosure, the context information may include at least one of user account information, location information, or time information of the electronic device.

According to an embodiment of the disclosure, the second data may include information indicating a priority of the applications, and the processor may be configured to display the list on the display depending on the priority.

According to an embodiment of the disclosure, the information indicating the priority of the applications may be based on at least one of the user account information, the location information, the time information, alphabetical order of the names of the applications, or usage history of the electronic device.

According to an embodiment of the disclosure, the location information may include network information of a network to which the electronic device is connected, and the list of the applications may include a user-specific application group or a generic application group which is determined based on the network information.

According to an embodiment of the disclosure, the network information may indicate at least one of a type of the network to which the electronic device is connected, a speed of the network, connectivity of the network, capability of the network, service availability of the network, or a type of an edge server.

According to an embodiment of the disclosure, the instructions may cause the processor to display an execution screen of an application included in the list of the applications via the display based on a user utterance received to the AI device.

According to an embodiment of the disclosure, the electronic device may further include a sensor sensing motion of the electronic device. The processor may be configured to obtain the image, while the camera watches the AI device, when the motion of the electronic device is not sensed during a specified critical time or when a user input is received.

As described above, according to an embodiment of the disclosure, a system (e.g., 100 of FIG. 1) may include at least one communication interface, at least one processor operatively connected to the communication interface, and at least one memory operatively connected to the processor, wherein the memory stores information about an external speech recognition device. The memory may store instructions that, when executed, cause the processor to receive first data including an image and context information from an AR electronic device associated with a user account of the external speech recognition device via the communication interface, recognize the speech recognition device included in the image, determine a list of applications installed in an AI system including the speech recognition device based on the context information and the information about the speech recognition device stored in the memory, and transmit second data including the list of the applications to the AR electronic device via the communication interface.

According to an embodiment of the disclosure, the instructions, when executed, may cause the processor to determine whether the speech recognition device is associated with the user account based on location information included in the context information and determine the list of the applications supported by the speech recognition device based on the information about the speech recognition device stored in the memory when the speech recognition device is associated with the user account.

According to an embodiment of the disclosure, the instructions, when executed, may cause the processor to determine a priority of the applications based on at least one of user account information, time information, or the location information of the electronic device included in the context information and further to insert the priority of the applications to the second data.

According to an embodiment of the disclosure, the instructions, when executed, may cause the processor to identify a connection environment of the speech recognition device based on network information included in the context information and to determine a priority of the applications based on the connection environment, and further to insert the priority of the applications to the second data.

According to an embodiment of the disclosure, the instructions, when executed, may cause the processor to identify the connection environment of the speech recognition device based on at least one of a type, speed, connectivity, capability, or service availability of network to which the electronic device is connected, which is included in the network information.

According to an embodiment of the disclosure, the instructions, when executed, may cause the processor to determine a type of the speech recognition device based on information of an edge server to which the electronic device is connected which is included in the context information and to determine the list of the applications supported by the speech recognition device based on the type of the speech recognition device and the information about the speech recognition device stored in the memory.

According to an embodiment of the disclosure, the instructions, when executed, may cause the processor to generate rendering information of content indicating the list of the applications and further to insert the rendering information to the second data.

As described above, according to an embodiment of the disclosure, a method of operating an electronic device in an AR environment may include obtaining an image including an external speech recognition-based AI device which is associated with a user account of the electronic device, transmitting first data including the image and context information to an external electronic device, receiving second data including a list including names of applications installed in an AI system including the AI device from the external electronic device, and displaying a GUI including the list based on the second data so as to be adjacent to or overlapped with a speech recognition device.

According to an embodiment of the disclosure, the obtaining of the image may include receiving a first user input to execute an AR mode in a state where the electronic device is worn on a part of a user's body, receiving a second user input to execute at least one application supported by the speech recognition device in the AR mode, and obtaining the image in response to the second user input.

According to an embodiment of the disclosure, the second data may indicate a priority of the applications, and the displaying of the GUI may include sequentially displaying names of the applications depending on the priority.

According to an embodiment of the disclosure, the method may further include receiving a user utterance input based on the displayed GUI, transmitting the received user utterance input to the external electronic device, receiving an application execution screen based on the user utterance input from the external electronic device, and displaying the received application execution screen.

According to an embodiment of the disclosure, the displaying of the GUI may include displaying content of the applications in response to a user utterance input to call the speech recognition device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for corresponding embodiments. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented using hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, a module may be implemented in a form of an application-specific integrated circuit (ASIC).

Various embodiments as set forth herein may be implemented as software (e.g., the program 440) including one or more instructions that are stored in a storage medium (e.g., the internal memory 436 or external memory 438) that is readable by a machine (e.g., the electronic device 401). For example, a processor (e.g., the processor 420) of the machine (e.g., the electronic device 401) may invoke at least one of the one or more instructions stored in the storage medium, and execute it, with or without using one or more other components under the control of the processor. This allows the machine to be operated to perform at least one function according to the at least one instruction invoked. The one or more instructions may include a code made by a complier or a code executable by an interpreter. The machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments of the disclosure, each component (e.g., a module or a program) of the above-described components may include a single entity or multiple entities. According to embodiments of the disclosure, one or more of the above-described components may be omitted, or one or more other components may be added. Alternatively or additionally, a plurality of components (e.g., modules or programs) may be integrated into a single component. In such a case, according to embodiments of the disclosure, the integrated component may still perform one or more functions of each of the plurality of components in the same or similar manner as they are performed by a corresponding one of the plurality of components before the integration. According to embodiments of the disclosure, operations performed by the module, the program, or another component may be carried out sequentially, in parallel, repeatedly, or heuristically, or one or more of the operations may be executed in a different order or omitted, or one or more other operations may be added.

According to embodiments disclosed in this disclosure, an AR electronic device visually displays the list of applications (or content) of the AI system, thereby providing an environment in which a user can utilize various functions.

According to embodiments disclosed in this disclosure, an electronic device may provide an environment in which a user can access information about the application or function that the AI system supports, without using the voice command.

According to embodiments disclosed in this disclosure, the electronic device provides an environment in which the user can easily look up the 3rd party application (or skill) added to the AI system without remembering the 3rd party application, thereby improving the usability.

According to embodiments disclosed in this disclosure, the electronic device may display the list of applications so as to easily identify one or more applications recommended to use an AI speaker based on the context (e.g., one or more of the profile of a user, the location of a user, the time of a user, usage frequency of an application, the registered schedule, or whether another user is present) of the user, and may provide an environment for selecting an application, thereby improving the usability.

While the disclosure has been shown and described with reference to various embodiments thereof, it will be understood by those skilled in the art that various changes in form and detail may be made therein without departing from the spirit and scope of the disclosure as defined by the appended claims and their equivalents.

What is claimed is:

1. An electronic device comprising:
a display;
a camera;
a wireless communication circuit;
at least one processor operatively connected to the display, the camera, and the wireless communication circuit; and
a memory operatively connected to the at least one processor,
wherein the memory stores instructions that, when executed, cause the at least one processor to:
obtain an image including an external speech recognition-based artificial intelligence (AI) device which is associated with an account of a user of the electronic device via the camera,
transmit first data including the image and context information to an external electronic device via the wireless communication circuit,
receive second data including a list including names of applications installed in an AI system including the AI device from the external electronic device via the wireless communication circuit, and
display a graphical user interface (GUI) on the display, based at least partly on the second data, wherein the GUI includes the list adjacent to or at least partly overlapping with an image of the AI device.

2. The electronic device of claim 1, wherein the context information comprises at least one of user account information, location information, or time information of the electronic device.

3. The electronic device of claim 2,
wherein the second data comprises information indicating a priority of the applications, and
wherein the instructions further cause the at least one processor to display the list on the display based on the priority.

4. The electronic device of claim 3, wherein the information indicating the priority of the applications is based on at least one of the user account information, the location information, the time information, alphabetical order of the names of the applications, or usage history of the electronic device.

5. The electronic device of claim 2,
wherein the location information comprises network information of a network to which the electronic device is connected, and
wherein the list of the applications comprises a user-specific application group or a generic application group which is determined based on the network information.

6. The electronic device of claim 5, wherein the network information indicates at least one of a type of the network to which the electronic device is connected, a speed of the network, connectivity of the network, capability of the network, service availability of the network, or a type of an edge server connected to a base station of the network.

7. The electronic device of claim 1, wherein the instructions further cause the at least one processor to display an execution screen of an application included in the list of the applications via the display, based at least partly on a user utterance received by the AI device.

8. The electronic device of claim 1, further comprising:
a sensor configured to detect a motion of the electronic device,
wherein the instructions further cause the at least one processor to, while the camera is directed toward the AI device, obtain the image when the sensor detects substantially no motion of the electronic device during a selected period of time or in response to a user input.

9. A system comprising:
at least one communication interface;
at least one processor operatively connected to the communication interface; and
at least one memory operatively connected to the at least one processor,
wherein the memory stores information about an external speech recognition device, and
wherein the memory stores instructions that, when executed, cause the processor to:
receive first data including an image and context information from an augmented reality (AR) electronic device associated with a user account of the external speech recognition device via the communication interface,
recognize the speech recognition device included in the image,
determine a list of applications installed in an artificial intelligence (AI) system including the speech recognition device, based at least partly on the context information and the information about the speech recognition device stored in the memory, and
transmit second data including the list of the applications to the AR electronic device via the communication interface.

10. The system of claim 9, wherein the instructions, when executed, further cause the at least one processor to:
determine whether the speech recognition device is associated with the user account, based at least partly on location information included in the context information, and
when the speech recognition device is associated with the user account, determine the list of the applications supported by the speech recognition device, based at least partly on the information about the speech recognition device stored in the memory.

11. The system of claim 10, wherein the instructions, when executed, further cause the at least one processor to:
determine a priority of the applications based at least partly on at least one of user account information, time information, or the location information of the electronic device included in the context information, and
add the priority of the applications to the second data.

12. The system of claim 10, wherein the instructions, when executed, further cause the at least one processor to:
identify a connection environment of the speech recognition device, based at least partly on network information included in the context information,
determine a priority of the applications, based at least partly on the connection environment, and
add the priority of the applications to the second data.

13. The system of claim 12, wherein the instructions, when executed, further cause the at least one processor to:
identify the connection environment of the speech recognition device, based at least partly on at least one of a type, speed, connectivity, capability, or service availability of network to which the electronic device is connected, which is included in the network information.

14. The system of claim 10, wherein the instructions, when executed, further cause the at least one processor to:
determine a type of the speech recognition device based on information of an edge server to which the electronic device is connected, which is included in the context information, wherein the edge server is connected to a base station of the network; and
determine the list of the applications supported by the speech recognition device, based at least partly on the type of the speech recognition device and the information about the speech recognition device stored in the memory.

15. The system of claim 9, wherein the instructions, when executed, further cause the at least one processor to:
generate rendering information of content representing the list of the applications, and
add the rendering information to the second data.

16. A method of operating an electronic device in an augmented reality (AR) environment, the method comprising:
obtaining, by an electronic device including a camera and a display, an image including an external speech recognition-based artificial intelligence (AI) device associated with a user account of the electronic device, using the camera;
transmitting, by the electronic device, first data including the image and context information to an external electronic device;
receiving, by the electronic device, second data including a list including names of applications installed in an AI system including the AI device from the external electronic device; and
displaying, by the electronic device, a graphical user interface (GUI) on the display, based at least partly on the second data, wherein the GUI includes the list adjacent to or at least partly overlapping with an image of the AI device.

17. The method of claim 16, wherein obtaining the image includes:
receiving, by the electronic device, a first user input to execute an AR mode while the electronic device is worn on a part of a user's body;
receiving, by the electronic device, a second user input to execute at least one application supported by the speech recognition device, in the AR mode; and
obtaining, by the electronic device, the image in response to the second user input.

18. The method of claim 16,
wherein the second data indicates a priority of the applications, and
wherein displaying the GUI comprises displaying names of the applications in an order, based at least partly on the priority.

19. The method of claim 16, further comprising:
displaying, by the electronic device, an execution screen of an application included in the list of the applications, on the display, based at least partly on a user utterance received by the AI device.

20. The method of claim 16, wherein displaying of GUI comprises displaying content of the applications in response to a user utterance to wake up the speech recognition device.
